(19) United States
(12) Patent Application Publication
(10) Pub. No.: US 2006/0212933 A1
(43) Pub. Date: Sep. 21, 2006

(54) Surveillance implementation in a voice over packet network

(75) Inventors: Shwu-Yan Chang Scoggins, Oak Hill, VA (US); Manoj Sindhwani, Oak Hill, VA (US); Chander Raja, Washington, DC (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/411,912

(22) Filed: Apr. 27, 2006

Related U.S. Application Data
(63) Continuation-in-part of application No. 11/054,969, filed on Feb. 10, 2005.
(60) Provisional application No. 60/543,755, filed on Feb. 11, 2004.
(60) Provisional application No. 60/545,549, filed on Feb. 18, 2004.
(60) Provisional application No. 60/624,668, filed on Nov. 3, 2004.
(60) Provisional application No. 60/626,595, filed on Nov. 10, 2004.

(51) Int. Cl. G06F 15/16

(52) U.S. Cl. 726/11

(57) ABSTRACT

A network infrastructure device in a voice over packet (VOP) network includes a transceiver and a processor. The transceiver can transmit and receive communications over a VOP network. The processor, responsive to receipt of a call setup information request (CIReq) specifying a particular target, can associate a public identifier with the particular target, and map the public identifier to an internet protocol (IP) address responsive to a communication. Also, the processor can identify communications to and/or from the particular target with the IP address. Further, responsive to receiving communications to and/or from the IP address, the processor can transmit the communications to a law enforcement agency (LEA) collection device.

### CROSS-REFERENCE TO RELATED APPLICATIONS

This application is a continuation-in-part of U.S. patent application Ser. No. 11/054,969, filed Feb. 10, 2005, which claims the benefit of the following Provisional applications: 60/543,755 filed Feb. 11, 2004; 60/545,549 filed Feb. 18, 2004; 60/624,668 filed Nov. 8, 2004; and 60/626,595 filed Nov. 10, 2004, all of which are expressly incorporated herein by reference.

### STATEMENT REGARDING FEDERALLY SPONSORED RESEARCH OR DEVELOPMENT

Not applicable.

### FIELD OF THE INVENTION

The present invention relates in general to the communication networks, and more specifically to surveillance of communications on voice-over-packet (VOP) networks.

### BACKGROUND OF THE INVENTION

The Communications Assistance for Law Enforcement Act (CALEA) requires that communications networks provide means to support electronic surveillance of communications traffic. For example, surveillance can be readily accomplished in a public switched telephone network (PSTN) because all traffic in a PSTN must flow from a class 5 switch and must flow through the local exchange carrier, with a known origination and destination.

The goals of security services include providing privacy, packet integrity, authentication, and/or non-repudiation of packets in a communications network. Privacy means the packets are not intercepted; packet integrity means the packets have not been modified; authentication means that the person involved in the communication is who he/she claims to be; and non-repudiation means the message sent and received cannot be denied. Packets can be data, voice, signals, video, image, and/or any other format.

CALEA is understood to refer to electronic surveillance. Electronic surveillance in accordance with CALEA means that the legal enforcement agent taps into a communication channel to obtain, but not alter, the packets on the communication channel. The Federal Communications Commission (FCC) enacted CALEA in October 1994. In response to CALEA, in December 1997, the Telecom Industry Association (TIA) developed J-STD-025 (J-Standard) to include wireline, cellular, and broadband Personal Communication Services (PCS) carrier and manufacturers. The FCC ruled on Aug. 26, 1999 that packet communications interception is required to be in place by Sep. 30, 2001. On Aug. 9, 2004, FCC published a Notice of Proposed Rulemaking (NPRM) wherein wireless, wireline broadband internet access service, and managed Voice over Internet Protocol (VoIP) are subject to CALEA. The NPRM specifies that wireless, wireline broadband internet access, and managed VoIP are covered within the scope of “Telecommunication Carrier.”

### BRIEF DESCRIPTION OF THE DRAWINGS

Exemplary embodiments of the invention are discussed hereinafter in reference to the following drawings, in which:

FIG. 1A is a functional block diagram of a PSTN network with CALEA implemented to provide for surveillance of traffic.

FIG. 1B shows an example implementation of the call flow of the PSTN CALEA model.

FIG. 2 is block diagram of the functional components of a packet network for transmission of VOP packets.

FIG. 3 is a functional block diagram of a current model of electronic surveillance according to the Packet Cable specification for CALEA.

FIG. 4A is a functional block diagram of a first exemplary embodiment model for implementation of enhanced of electronic surveillance according to a first exemplary embodiment.

FIG. 4B is an exemplary call setup/flow diagram for the embodiment of FIG. 4A.

FIG. 5A is a functional block diagram of a second exemplary embodiment model for implementation of enhanced of electronic surveillance according to a second exemplary embodiment.

FIG. 5B is an exemplary call setup/flow diagram for the embodiment of FIG. 5A.

FIG. 6A is a functional block diagram of a third exemplary embodiment model for implementation of enhanced of electronic surveillance.

FIG. 6B is an exemplary call setup/flow diagram for the embodiment of FIG. 6A.

FIG. 7A is a functional block diagram of a fourth exemplary embodiment model for implementation of enhanced of electronic surveillance.

FIG. 7B is an exemplary call setup/flow diagram for the embodiment of FIG. 7A.

FIG. 8A is a functional block diagram of a fifth exemplary embodiment model for implementation of enhanced of electronic surveillance.

FIG. 8B is an exemplary call setup/flow diagram for the embodiment of FIG. 8A.

FIG. 9A is a depiction of the first model of CALEA implementation for managed networks.

FIG. 9B is a depiction of the second model of CALEA implementation for managed networks, utilizing a mediation device.

FIG. 9C is a depiction of the third model of CALEA implementation for managed networks, utilizing an external (third party) system.

FIG. 10 is a flow diagram depicting the surveillance development and implementation procedure in accordance with one or more exemplary embodiments.

FIG. 11 is a key to the network diagrams listed above.

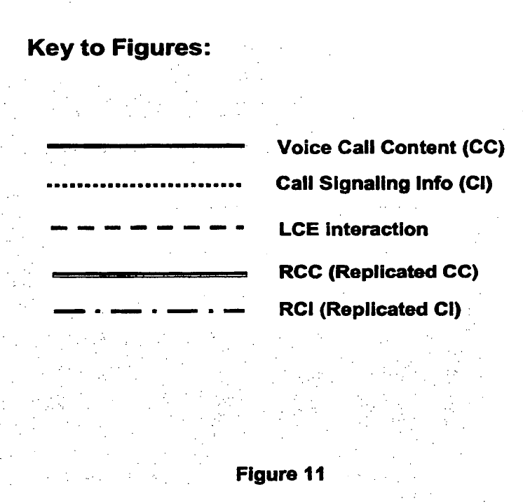

FIG. 12 is a block diagram illustrating portions of an exemplary infrastructure device in accordance with various exemplary embodiments.

FIG. 13 is a flow chart illustrating an exemplary procedure for providing surveillance of communications on a voice over packet (VOP) network in accordance with various exemplary and alternative exemplary embodiments.

FIG. 14 is a flow chart illustrating an exemplary procedure for mapping a public identifier to an Internet protocol address.

### DETAILED DESCRIPTION

In overview, the present disclosure concerns communication networks, often referred to as voice over packet (VOP) networks, such as may be associated with networks supporting voice communication between wireless and/or wire line devices. Such communication networks may provide additional services such as data communications, signal, and/or video services. Such networks can include network infrastructure devices which transfer the communications between wireless and/or wire line devices, for example by forwarding the communications which may have been broken into communication packets. More particularly, various inventive concepts and principles are embodied in systems, devices, and methods therein for providing surveillance of voice communications in a VOP network.

The network infrastructure devices of particular interest are those providing or facilitating voice communications services networks, such as edge routers, media gateways, centralized media gateways, session border controllers, trunk gateways, gateways, call servers, and the like, and variants or evolutions thereof.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

CALEA and security have conflicting objectives. In a secured network, CALEA should not function, and yet, the United States TIA requires service providers for Public Switched Telephone Networks (PSTN) and packet networks to provide means to support CALEA. All PSTNs have been supporting CALEA, but support for CALEA in a Voice over Packet (VoP) network has not been fully implemented because there are still many unresolved issues, including those discussed below.

A security mechanism starts with establishing a Security Association (SA) between two endpoints. Establishment of a SA requires two steps.
(i) The first step is to authenticate both end-points.
(ii) The second step is to exchange security keys for encryption and decryption referred to herein generally as signaling security information, as well as media security information.

If there is at least one device in the path involved in SA establishment, then the SA is in a “transport” mode and one of the middle boxes terminates one endpoint's SA and establishes an SA with another endpoint. After an SA is established, both end-points can encrypt and decrypt the packets using the security keys. Between the two end-points, there are many other devices in the path. The involved intermediate device is called a Security Gateway (SGW). A SGW has and issues the security keys to encrypt and decrypt packets from both end-points. The end-points encrypt or decrypt the packets. Law enforcement has access to the SGW through the service provider's network.

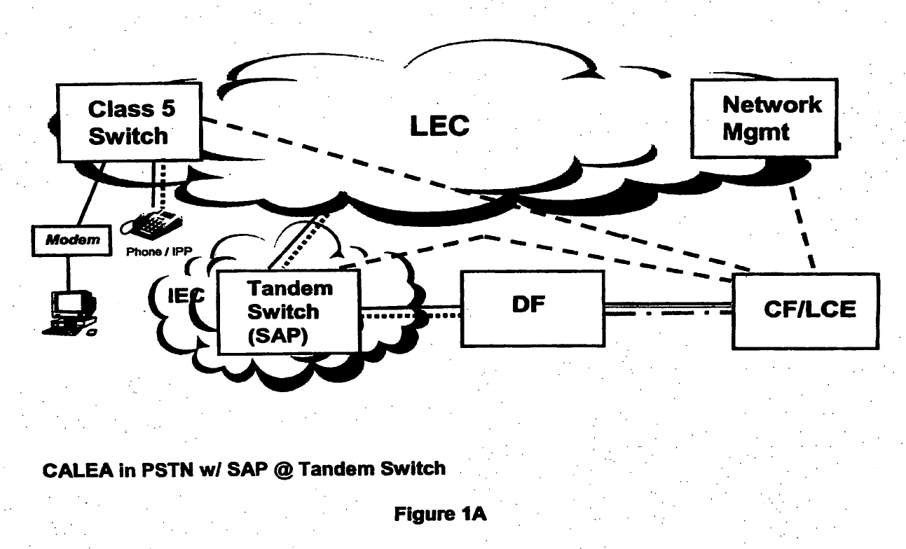

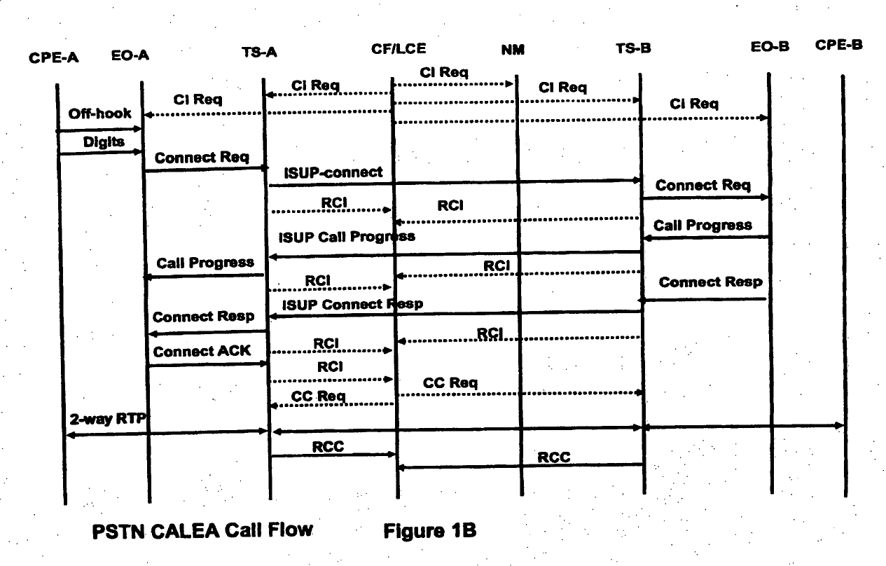

An example of a conventional PSTN CALEA implementation is illustrated in FIGS. 1A and 1B. FIG. 1A is a functional block diagram of a CALEA in PSTN with surveillance access point (SAP) at Class 5 switch call server and tandem switch. FIG. 1B shows the call flow of the PSTN CALEA model. The Law Enforcement Agency (LEA) needs the service provider to provision the network management device and the class 5 switch to cooperate with the Lawful Collection Equipment (LCE). The class 5 switch will direct targeted calls to a specified tandem switch (class 3 or 4 switch) located within the domain of an inter-exchange carrier (IEC). This is true even for the case that both the originator and terminator are on the same class 5 switch. This minimizes the need for modifying every class 5 switch to support CALEA. The class 5 switch call server port and the tandem switch are the SAP in this circumstance. The PSTN CALEA model is centralized.

The Federal Communications Commission (FCC) also requires that managed Voice Over Packet (VOP), as well as Broadband Internet Access, and Wireless Internet Access, be subject to the Communications Assistance for Law Enforcement Act (CALEA). However, there are no technical guidelines defined by the FCC for implementation of CALEA in these new areas. There is little literature on the implementation of CALEA, and many unanswered questions remain on the feasibility of supporting CALEA in VOP products. CALEA only requires the service provider (SP) to deliver intercepted packets. The SP is not required to provide decryption of the intercepted packets.

Packet network service providers, among others, are required to comply with CALEA and provide means to support electronic surveillance of traffic in their networks. A publication entitled “Packet Cable Electronic Surveillance Specification” has been adopted by the Federal Bureau of Investigation as the governing specification for the required support means.

Compliance with the Packet Cable specification is defined in terms of supporting electronic surveillance via a variety of data interception, delivery and collection functions on networks operating in what is known as “transport mode.” In transport mode, Security Associations (SA) are established between at least one type of security gateway (SGW) in a network and either another SGW or an end-user device attached to that network. The SGW is typically a device within a cable modem termination system (CMTS) which performs encryption and decryption of user messages, including creation and storage of the encryption keys facilitating the secure communications between the two points on the network. Compliance with the Packet Cable specification involves enabling the establishment of surveillance links between law enforcement controlled surveillance intercept boxes and the security gateways on the provider's network.

The Packet Cable security specification defines security only in a transport mode, while many broadband virtual private networks (VPN) run on a tunnel mode. This presents some new challenges in security for electronic surveillance. Furthermore, the Packet Cable Electronic Surveillance Specification defines the security model starting from the Cable Modem Terminal System (CMTS), while many VPNs start encryption at the end devices (PCs or IP phones) that are attached to the Multimedia Terminal Adaptor/Cable Modem (MTA/CM) and tunnel through the CMTS and/or Media Gateway (MG). Only those end devices know the security keys and associated parameters. Secured realtime transport protocol (SRTP), providing end-to-end encryption for voice, is yet another concern. Not only is encryption/decryption a challenge, but also it is difficult to intercept the message in some cases, such as in the presence of network address translation (NAT).

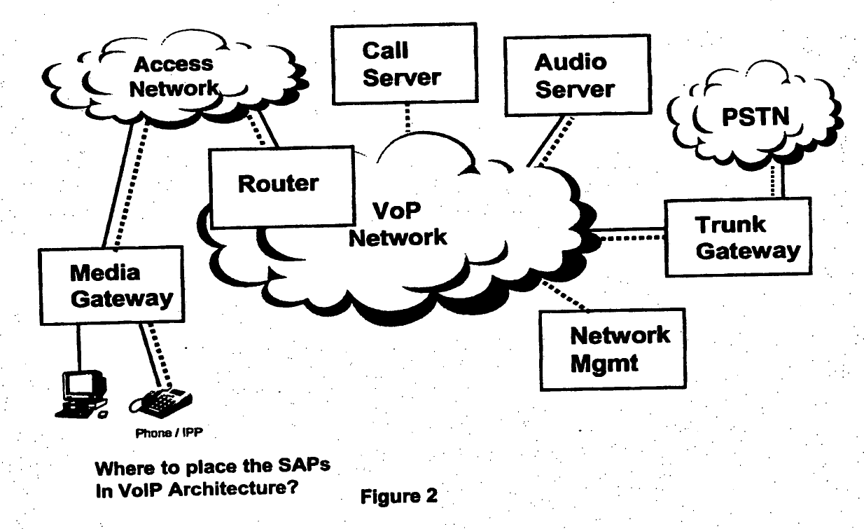

The VoIP (voice over IP) call flows discussed below are illustrated utilizing SIP, however, VoIP can be implemented using different signaling protocols, and the call flow should be similar. An example of a VOP packet network is illustrated in FIG. 2. The class 5 switch of a PSTN is roughly equivalent to a Media Gateway (MGW) and a Call Server (CS).

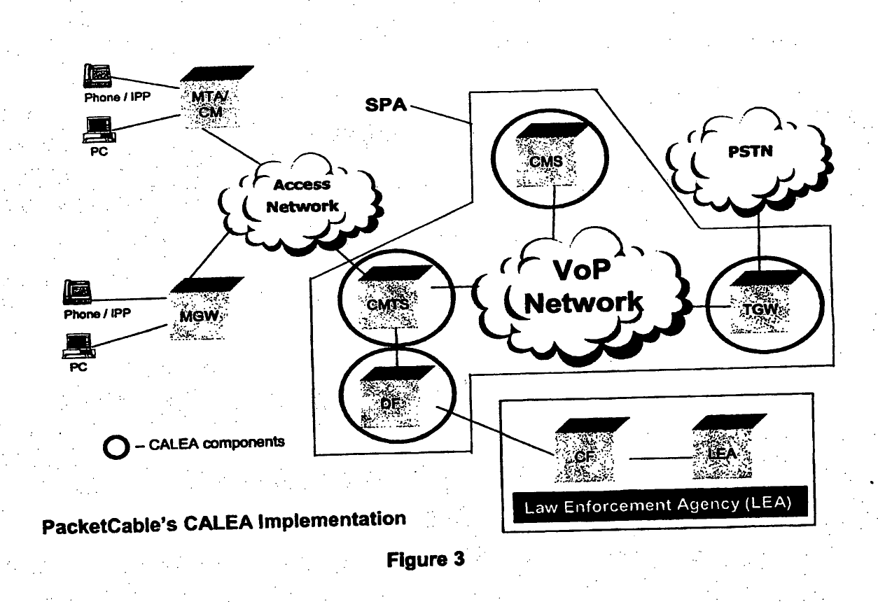

Surveillance in a VOP network can be accomplished in a variety of ways such as under the Packet Cable specification. For example, as shown in FIG. 3, when the provider is a cable network, the surveillance “delivery function” (DF) of the Packet Cable specification is required to take place within the domain of the service provider's administration (SPA), as an adjunct to the operation of the CMTS, i.e., tapping into the system to create a surveillance access point (SAP) for law enforcement interception of call-identifying information, encrypted packet messages and the provider's encryption keys. This takes place upstream of user-controlled multimedia terminal adaptor and cable modems (MTA/CM) and Media Gateways (MGW).

The surveillance collector function (CF) resides within the domain of the law enforcement agency. The CF collects call transmissions intercepted by the DF and passes them to the law enforcement agency for monitoring and review. The CF is administered and controlled by the Law Enforcement Administrative (LEA) function within the law enforcement facility. This model of network provider support for CALEA, among others, is described in detail in the Packet Cable specification. This model works well only when the encryption functions are within the domain of the service provider. Other aspects of the CALEA surveillance model include intercepting call-identifying data through the provider's call management system (CMS) and intercepting call content at the trunk gateway (TGW) for calls redirected to the public switched telephone network (PSTN).

Unfortunately, there is a problem in complying with the specification from the standpoint of evolving technology, for example because transport mode is not the only packet communication mode used in VOP networks. VOP networks also employ “tunnel mode” where messages are encrypted within the end user's domain and simply pass (tunnel) through the provider's gateways and network. This end-to-end tunneling necessitates finding solutions which, while they will not comply exactly with the techniques of the surveillance specification, will comply with the intent of the Act.

Clarifying the packet transmission modes, there is: (a) TRANSPORT MODE: In a transport mode, the SGW can support the CALEA by providing encryption security keys to the CF intercepting box which is operated by the law enforcement agency; and (b) TUNNEL MODE: If no devices, other than the end-user devices, take part in security association establishment, then the SA is running in a tunnel mode. In this case, only the two end-points have the keys for encryption and decryption. The law enforcement agent can still intercept the packets, but they will not be able to decrypt the packets without the security keys.

Finding solutions for facilitating surveillance of VOP networks operating in tunnel mode presents many challenges. For example, as stated above, in transport mode, the provider-controlled security gateways, which are typically external to the end-user's physically controllable property, typically perform the functions of encryption and decryption for users of the network. These SGWs usually reside within a TGW, facilitating access to the PSTN, or within the CMTS in cable operator networks. The SGWs use provider-controlled encryption keys to encrypt information between connections. Since the security association is established via a service provider's gateways, the provider may configure the gateways such that both the encrypted message and the encryption key may be intercepted at those devices and sent to the law enforcement agency CF boxes whereupon the message may be decrypted and read by the agency.

In contrast however, when a packet network user operates in tunnel mode, encryption and decryption may be performed internal to an end-user's facility, typically at the subscriber's multimedia terminal adaptor or cable modem (MTA/CM), or at a residential enterprise media gateway (MGW), both of which are downstream of the SGW, for example, a CMTS, and reside on customer provided equipment (CPE). Security associations (SA) thus occur external to the service provider's domain. This means that, while the service provider may still enable the law enforcement agency to intercept an encrypted message, it will not have access to the end user's encryption key. Although law enforcement code-breaking may eventually achieve results, a tunnel mode network will not support CALEA in the manner that a transport mode will, as currently provided for in the Packet Cable specification.

In addition to dealing with encryption beginning downstream from a SGW, for example, a CMTS, when network address translation (NAT) is operating within the end-user's domain, the situation becomes even more complicated. The service provider equipment is not able to determine the particular user within an end-user facility that is sending the packets on the common Internet protocol (IP) address of the end-user's facility. This is particularly difficult when a large number of users on a local area network (LAN) are using a common access point to the Internet. This inability to identify an individual user presents an obstacle to law enforcement which may only seek to monitor a single user within an enterprise.

NAT provides a translation of private IP addresses (e.g. inside a corporate LAN or residential LAN) into public addresses in situations where an entity's network users outnumber the quantity of public addresses provided to that entity by its service provider (SP). Usually, the NAT function is performed on CPE prior to the message being received by the CMTS. In this case, a law enforcement surveillance access point (SAP) linked to the SGW or edge router would not have the decryption key, and would also not know the internal address of the end-user. In order for the law enforcement agency to be able to decode the entire transmission, it would need not only the encryption key but also the algorithm (e.g., IPsec, TLS), key exchange methods (such as public key, pre-shared key), and other parameters, used to code the translated address.

In summary, specifications including the Packet Cable Security Specification PKT-SP-SEC-1109-030728 and the Packet Cable Electronic Surveillance Specification PKT-SP-ESP4 102-0308 1 5 specify the security model only in a transport mode. These specifications do not describe how to achieve effective surveillance when the network is operating in tunnel mode.

As further discussed herein below, various inventive principles and combinations thereof are advantageously employed to provide surveillance of voice communications on a voice over packet (VOP) network. One or more embodiments provide surveillance devices and methods which support surveillance compliant with regulatory requirements.

Addressing the need to offer solutions to the evolving challenges of packet network surveillance, one or more embodiments can provide an electronic surveillance procedure for surveillance of communications in a VOP network. One or more embodiments can operate in transport mode, for example when encryption is performed by the service provider and law enforcement has access, and/or in tunneling mode, for example when end-to-end encryption and NAT are active upstream from a CMTS, i.e. at the end user premises. In one or more embodiments, end-user encryption setup messages passing through the network during call establishment can be intercepted at various points and used to effect end-user identification and decryption. In another model, MTA/CM's, MGW's and other downstream CPE devices can be targeted for surveillance operations wherever end-user address translation and security associations are accomplished through these devices.

In one embodiment, end-user NAT and/or encryption-capable devices can be targeted for surveillance as part of the delivery function (DF). Law enforcement compliant surveillance mechanisms allow tapping into NAT devices downstream of the CMTS to provide private address and SA information to the Agency when the end-user is operating in tunnel mode. The DF then delivers its collected data to the law enforcement agency-operated collection function (CF) where the data is reviewed and analyzed by the LEA.

For example, when a private IP address has been mapped to a public address through a NAT function, information on the private address can be intercepted at the point of conversion, linked to the associated message and then delivered to the law enforcement agency.

Further considering the example of the NAT function, the NAT unit has the following information for each private LAN device mapped to the public IP address:

private address;

RTP port# or application port #; and

public address.

In addition, the NAT unit may have the application specific algorithm (ALG) to handle the mapping. Some of the ALGs, such as SIP ALG, can provide user name or user ID, or phone number, or call ID or call leg number, and the like. The information can be valuable for filtering traffic before passing the traffic further, for example to the law enforcement agency. The information can also be passed down, for example to the law enforcement agency to help further diagnose the call. Some user information is critical in order to obtain the encryption key or other essential information.

Depending on the security association (SA) protocols, different information is passed between the two end points. For example, in Transport Layer Security (TLS), certification information given by the server to the client is included in the message. The client uses the certification information in a mathematical computation (which is specified in the TLS specification) to generate the encryption key. If the certificate can be intercepted, then the LEA can generate the encryption key.

TLS allows many different encryption protocols to be used. In the SA establishment stage, the message will include the encryption protocol name, such as Data Encryption Standard (DES), Triple Data Encryption Standard (3SDES), Advanced Encryption Standard (AES), etc. The encryption protocol name is essential to encrypt or decrypt the following messages. It may be essential for the law enforcement agency to obtain the encryption protocol name during the SA establishment stage. As soon as the SA is established, all the following messages will be encrypted and it will be hard to decrypt without the encryption protocol name and the encryption key.

After the SA has been established, any subsequent configuration and signaling messages will be encrypted. In the signaling messages or SA messages, the media stream encryption method and key may also be exchanged between two users. This is depending on the media encryption protocol and SA protocol. For example, the Session Description Protocol (SDP) in a Session Initiation Protocol (SIP) may contain a statement to exchange the encryption key, such as:

a=key-mgmt: data

If the law enforcement agency can intercept the SIP message and abstract the SDP in time, the subsequent media stream can be decrypted.

In addition, when security associations are performed without using a Packet Cable style CMTS, the DF will obtain the SA messages from the end-user (CPE) security management devices during security association establishment. Then the law enforcement agency may be able to interpret the SA messages to obtain the encryption method and keys and then collect and decrypt the transmitted media packets.

In a VOP network, the call signaling or call information (CI) packets take different paths from the voice message or call content (CC) packet paths:
(i) the signaling packets are transmitted between an end-point and a call server (CS) or proxy server (PS); and
(ii) the media packets are transmitted between the two end-points without involving a CS.

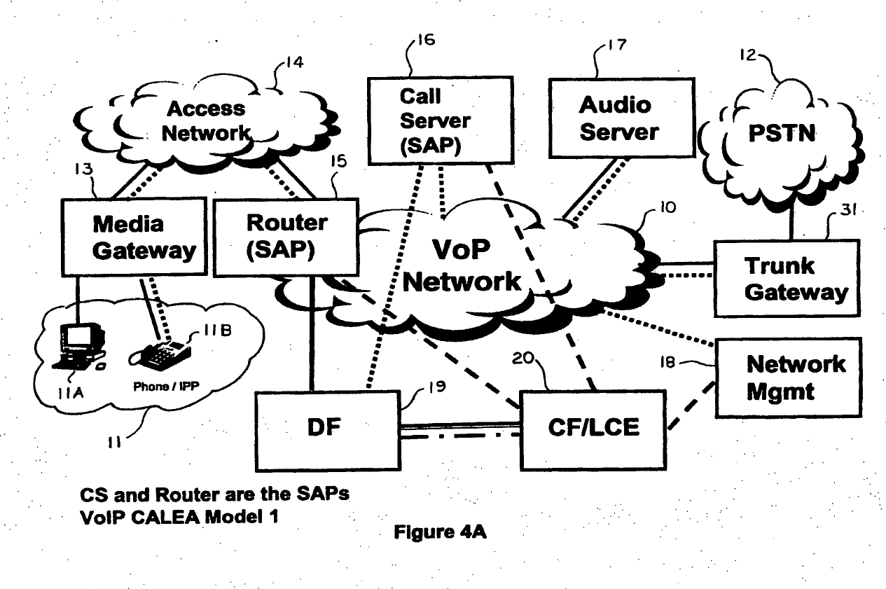

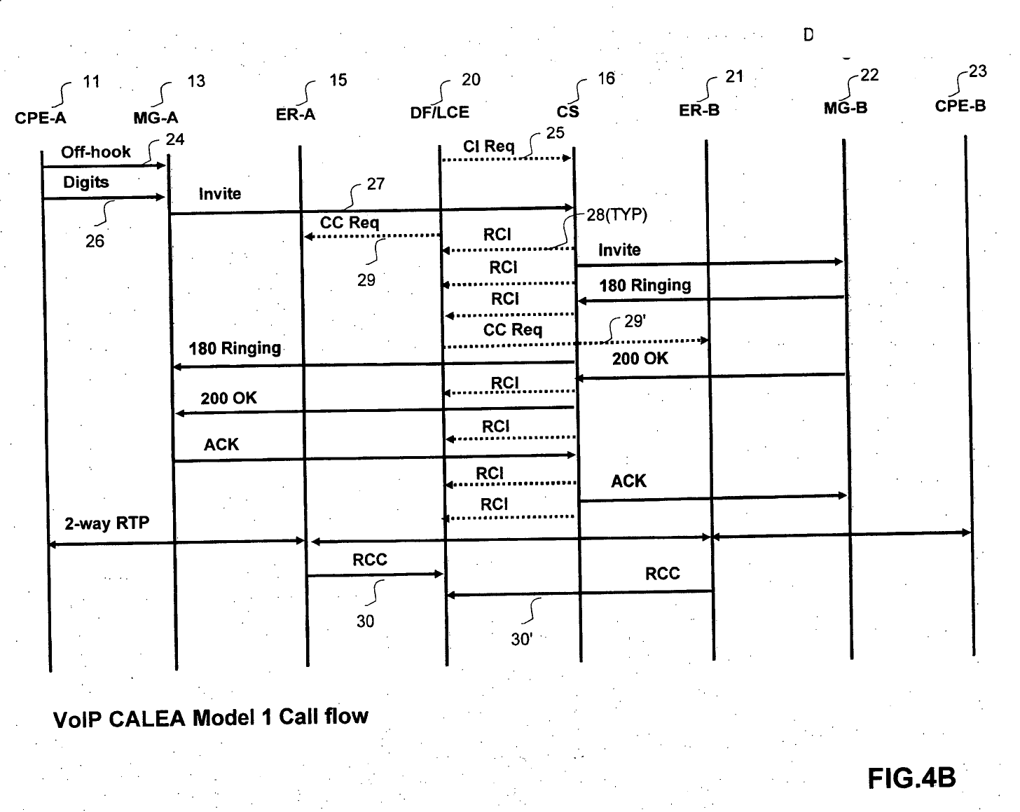

FIGS. 4A through 8B illustrate packet paths and call flows for a number of packet models.

There is one call set-up SA between an end-point and a CS or PS and a second call message SA between the two end-points. Each SA is independent from the other. The SA between an end-point and a CS or PS can be established once for all calls, on a per-call basis, or periodically after several calls, and it must be established before the SA is established between the two end-points on a per-call basis. In order for the call set-up SA not to be cracked by an intruder, it must have a limited life-time, which often is a few seconds to a few minutes.

Inside the call signal packets, the media path is specified in a different protocol, such as Session Description Protocol (SDP). The media path is determined by more than one parameter, such as real time transport protocol (RTP)/realtime transport control protocol (RTCP) port, and IP port. If the signaling path and the media description protocol cannot be decrypted and interpreted by a law enforcement agent, then it is difficult for the law enforcement agent to know which media stream the two end-points take. Thus, they will not be able to intercept and interpret the media packets.

Network Address Translation (NAT) can be used for a device to map a set of private IP addresses into one or more public IP addresses. For different transmission applications, such as SIP, SNTP, FTP, etc., there can be many ways, such as an application-specific algorithm (ALG), implemented for each application to pass through the NAT.

When the end-point encrypts its packets, which have a private IP address in the header and media description field, such as SDP, the NAT function can either have the security key to decrypt the packets and modify the address fields in the header and media description field, or it has to turn off the NAT function and assign each device with only a public IP address. If the security key is not given to the NAT device willingly by the end-point, the NAT device could implement the same mechanism as the CALEA intercept box does to obtain the key. However, the NAT device is, unlike the law enforcement agent, not legally permitted to intercept and interpret the packets. The law enforcement agent must obtain the security key and support of NAT with the ALG for the application in order to intercept the packets from the targeted devices.

There are many different security protocols to be used, for example, IP security protocol (IPSec), secure shell (SSH), SRTP, and the like. In each security protocol, different encryption/decryption protocols might be used. For example, IPSec allows for use any one of the following encryption protocols: Data Encryption Standard (DES), Triple Data Encryption Standard (3DES), and Advanced Encryption Standard (AES). In each encryption protocol, different key sizes can be used as well. The encryption protocol and key size, and possibly other parameters, are negotiated during SA establishment. A CALEA interception box can support a variety of security protocols and encryption methods and their associated parameters (such as key sizes).

Also, the PacketCable Electronic Surveillance Specification describes security in transport mode with interception performed at the CMTS, rather than the end-points, such as end-user PCs or IP Phones (IPPs). However, most security is implemented on the end-points in the current VOP market, and the majority of them operate in the tunnel mode.

In order to solve the security issues for CALEA, a CALEA interception box can intercept packets from the targeted devices during an early stage of SA establishment in order to obtain the security keys and other security parameters. Where to perform interception depends on many factors: NAT, Dynamic Host Configuration Protocol (DHCP), VPN/security end-point, etc.

In a voice signal processing system, depending on the signal processing protocol, different network elements will process different information. In some cases, intercepting the encryption protocol name and key is possible; in some cases, it is still impossible.

In a managed SIP or media gateway control protocol (MGCP) based VOP system, the proxy server (PS) or call server (CS) may have the master key that can be used to generate the encryption key, such as in the case of TLS protocol as described above. In that case, the PS/CS needs to cooperate with the DF and the LEA to provide this information in real-time. If any of the units are not providing essential information in real-time, the law enforcement agency will not know which media stream to intercept and therefore will not be able to monitor the call. The media stream is not stored anywhere in the network; once it is lost, it cannot be regenerated, unlike a data network, wherein the data is stored and forwarded.

In the case of peer-to-peer SIP communication with SIP encryption performed on the CPE endpoint device (the phone or PC), a SIP proxy or SIP server is not needed (no NAT function is required). Then, unless the user on the phone or PC is willing to cooperate, it is difficult to interpret the message and obtain the encryption protocol, name and key. If the above devices have no router function, then a router is needed. In that case, intercepting at the router as described earlier is possible.

If the VPN/security end-point is a PC or IPP, it will matter how the end-point obtains the IP address. The device may get its first IP address from the ISP. Then it gets a new IP address from its VPN to replace the first IP address. In this case, a tap on the first IP address my not get the correct packets. The LEA should tap on the second IP address.

When NAT is present, the best place to intercept is where the NAT function resides. In the existing Cable Network, there is no NAT function included. That is a deficiency. The NAT unit maps the private IP address to public IP address and vice versa, so the packets should be intercepted on the LAN site before NAT is performed. Otherwise, the interception box needs to do packet filtering in a stream of mixed messages with the same public IP address. Also the NAT unit has the application algorithm (ALG) to handle the application specific translation function. For example, an initial incoming SIP call has only a public IP address. In order to determine which private IP address to map the call to, the NAT has to run the SIP ALG, which uses the user ID in the SIP message, such as alice@wonderlane.com or the CallerID in the header, to find Alice's private IP address.

Note that Alice must have already registered her private IP address and her name and/or CallerID with the NAT device. Once the CALEA interception box is able to intercept the targeted device's packets, it should try to obtain the SA establishment messages. If the security mechanism is not based on the standard protocols, then the law enforcement agent will have a difficult time to interpret the security messages and subsequently decrypt the SA messages and media packets. If the security messages are based on the standard protocols, then from the SA establishment messages, the CALEA interception box should be able to figure out the key, key size, and encryption method.

The U.S. TIA has published a set of message formats for CALEA in PSTN. Since the Internet has completely different architecture, protocols, message formats, and call flows, TIA must publish a new set of specifications for CALEA on the Internet. The Packet Cable specifications can be a subset, and in fact, they are mentioned by TIA. However, modifications to Packet Cable Security Specification and Packet Cable Electronic Surveillance have to be made in order to support many VOP security requirements. Also, a VOP security solution that is not cable-based should be specified outside the Packet Cable specifications, although the principle may be the same.

There are some CALEA models addressed by the FCC, including one PSTN CALEA implementation. PacketCable has the defined a cable-based surveillance specification to support CALEA. Many people are looking into using PacketCable's specification as the guidelines for VOP CALEA implementation. However, there are limitations in PacketCable CALEA implementation. Five Voice over Packet (VOP) CALEA architecture models, including call flows, are discussed in the following sections. These five models are generic to any VOP networks, including VoIP.

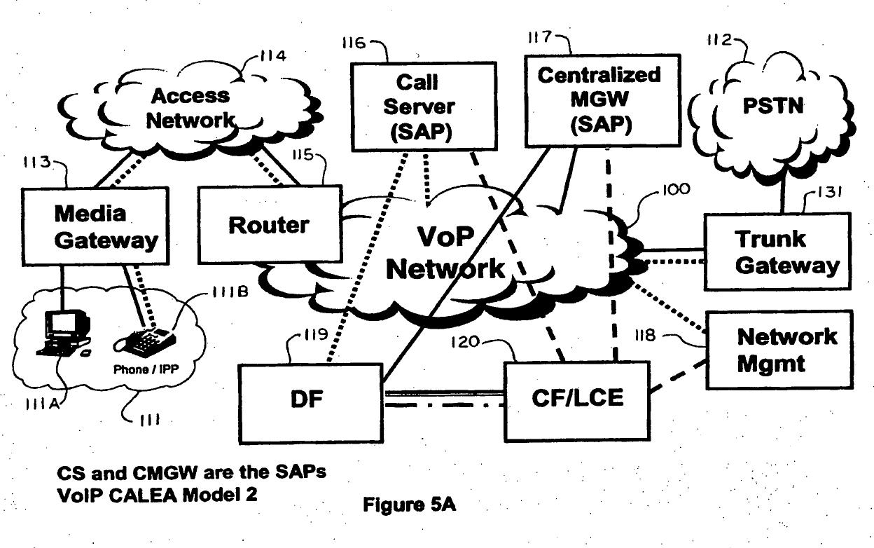

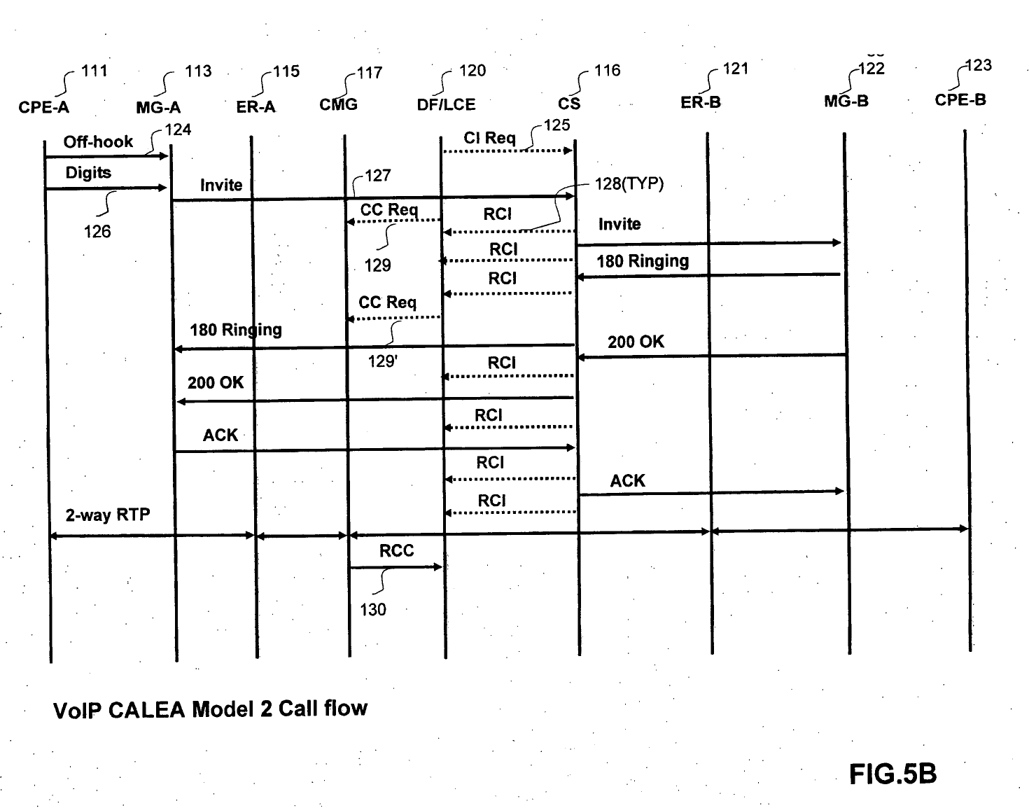

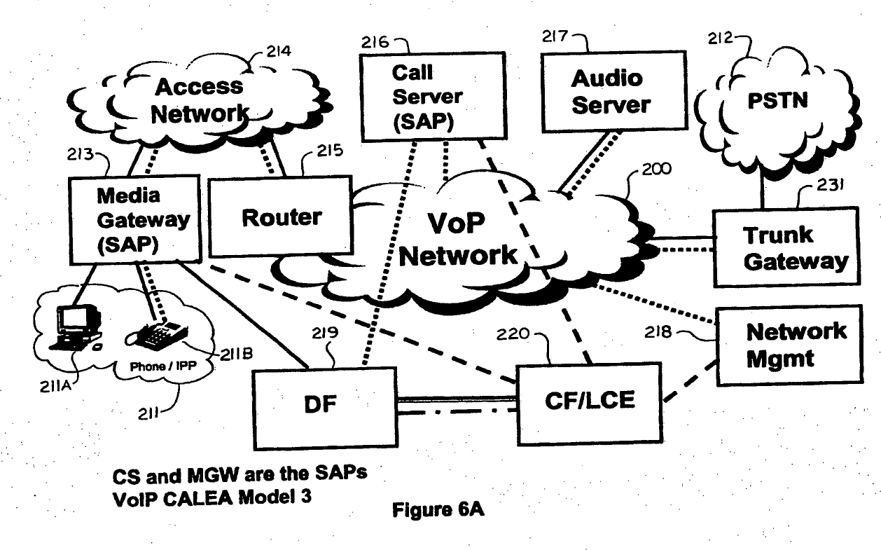

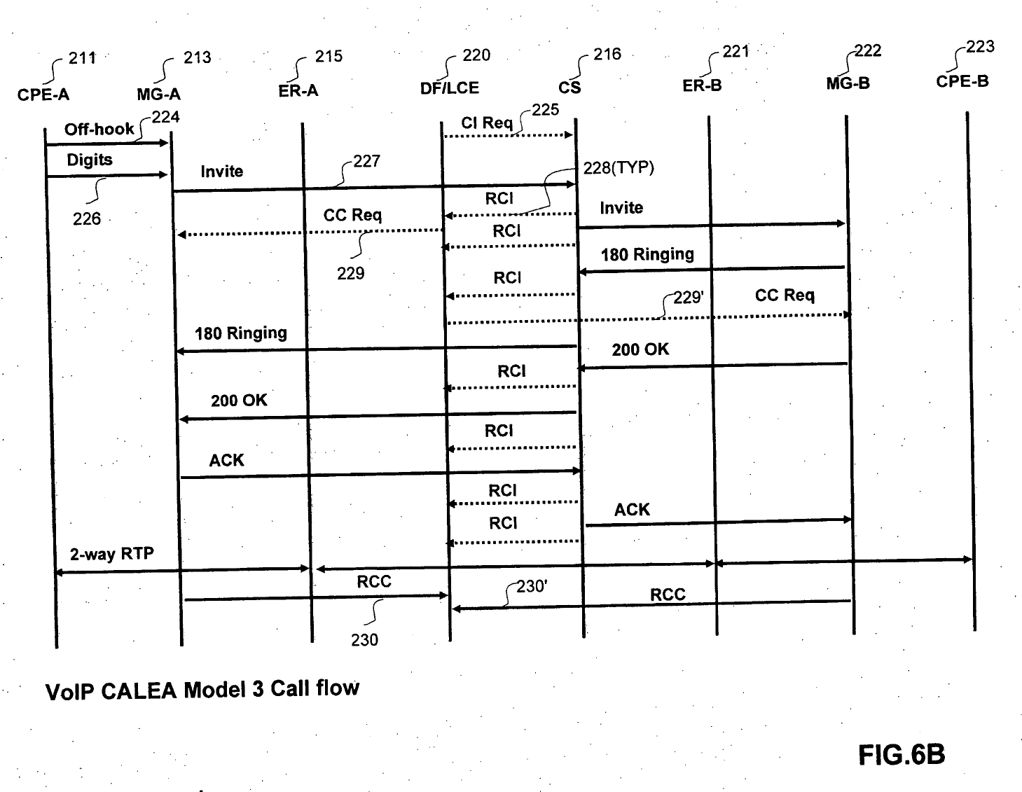

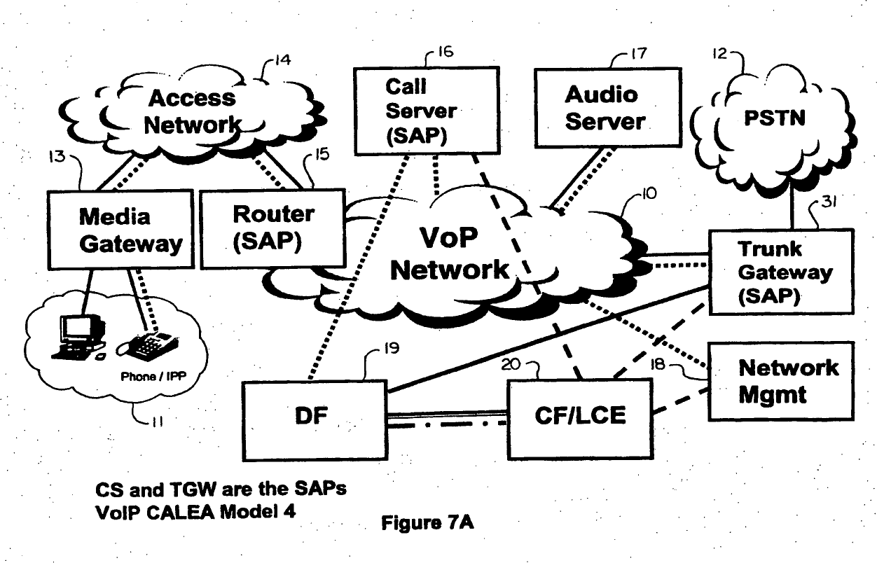

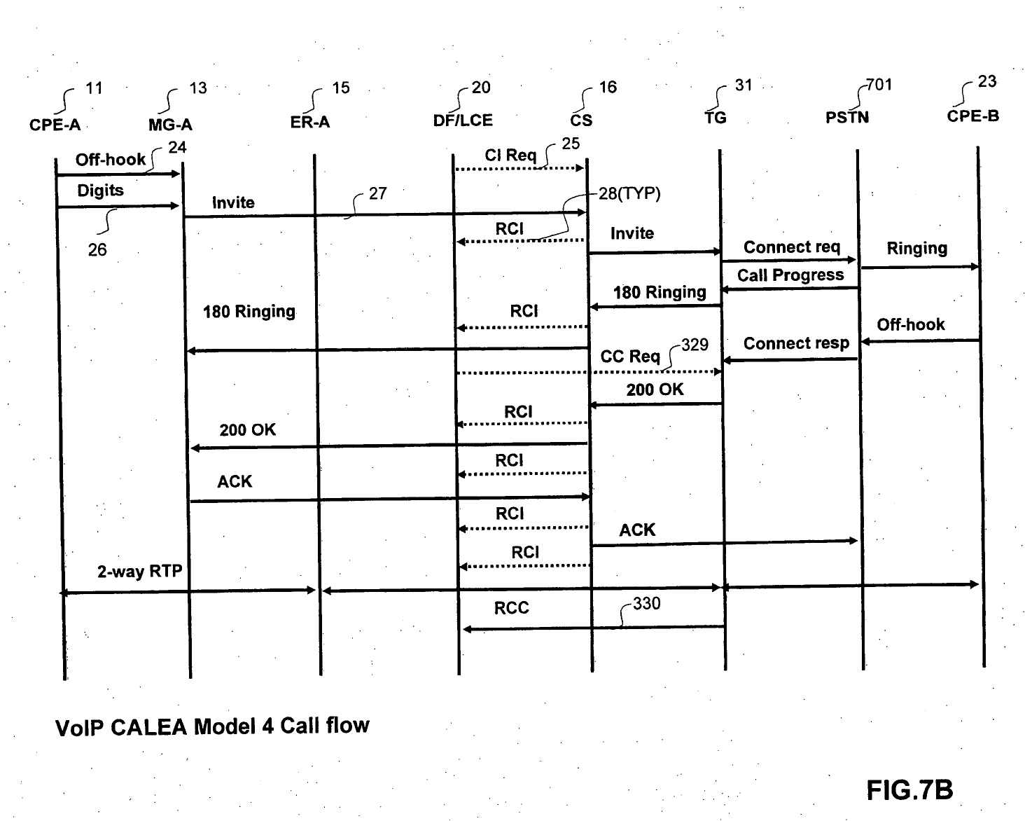

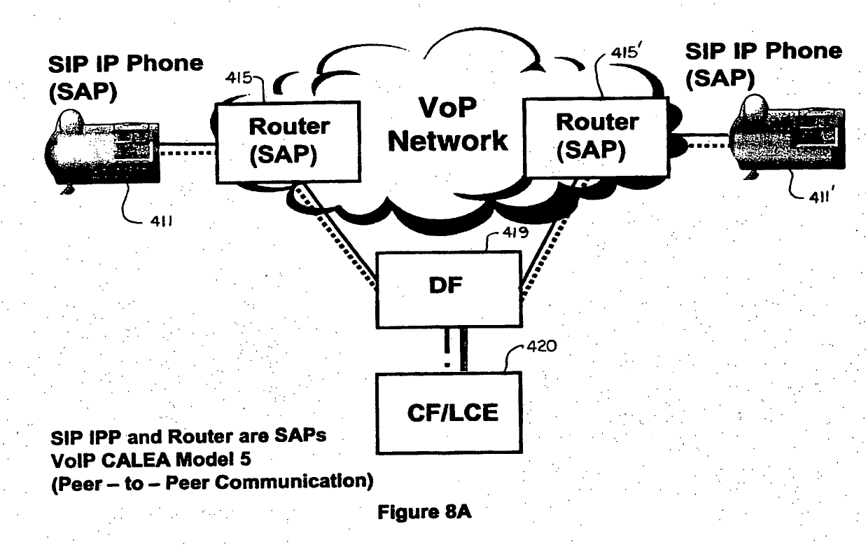

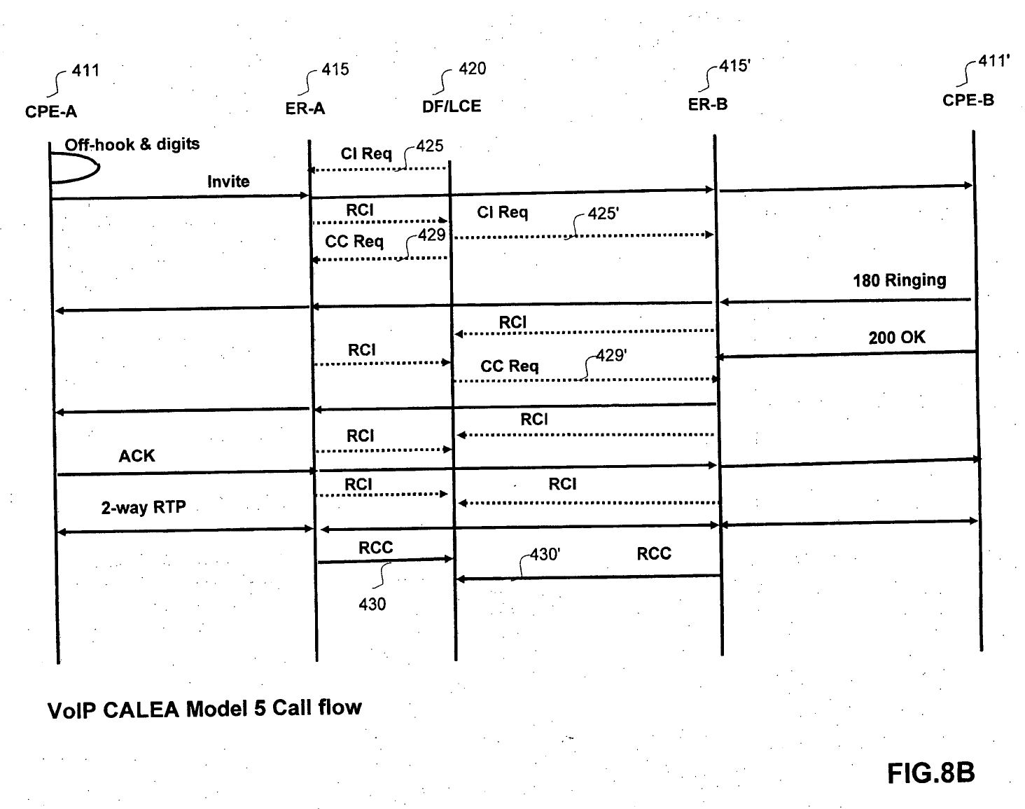

The first model, shown in FIG. 4A, defines the router as the Surveillance (or Security) Access Point (SAP). It is the recommended model, because the router has most of the information and capability to support CALEA. The second model, shown in FIG. 5A, defines the Call Server and the centralized media gateway (CMGW) as the secure access point. The third model, shown in FIG. 6A, puts the end-user's Media Gateway (MG) as the SAP. This model is not recommended because often the MG is purchased by the targeted end-user. When that is the case, the end-user may be able to thwart the surveillance operations by altering the device. The fourth model, shown in FIG. 7A, utilizes the Trunk Gateway (TGW) as the SAP. The TGW is needed to inter-work a provider network with a public switched telephone network (PSTN). The fifth model, as shown in FIG. 8A, is the peer-to-peer model. There is no call server and all call placement intelligence resides on the IP devices. This model is not considered to be a “managed” VOP network; therefore, it is not subject to CALEA requirements. However, the managed network portion of the model should attempt to facilitate CALEA.

Note that all call flow diagrams show SAPs for both end-users. In some cases, the Law Enforcement Agents will only set up the SAP for one targeted user. They may not know who the terminator will be or have no need to intercept, as one interception point is sufficient to intercept bi-directional traffic.

The goals for security services are to provide privacy, packet integrity, authentication and non-repudiation. Privacy means that packets cannot be intercepted. Packet integrity means that the packets have not been modified. Authentication means that the person involved in the communication is who he/she claims to be. Non-repudiation means the message sent and received cannot be denied. Because VOP needs to be as secure as possible, CALEA conflicts with the goal of privacy. A RTP media stream is only unidirectional. Therefore, being able to intercept both end users can be important.

The FCC published guidelines for implementing CALEA. The guidelines are unlike most communication standards and do not provide sufficient details for actual implementation. The FCC requirements are general, requiring a SAP to provide Call Information (CI), for example call control messages, or Call Contents (CC), for example media streams, or both in the formats and options that are compliant to the J-25 specification. The SAP allows access to CI and CC through the Delivery Function (DF) operation. The DF replicates the CC and CI and sends it to the LCE, which exists in conjunction with the Collection Function (CF) according to the CALEA formats and options. The CF resides with the law enforcement agency.

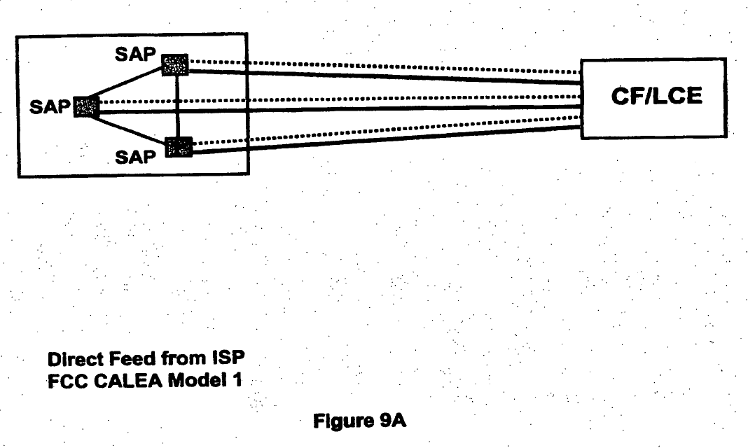

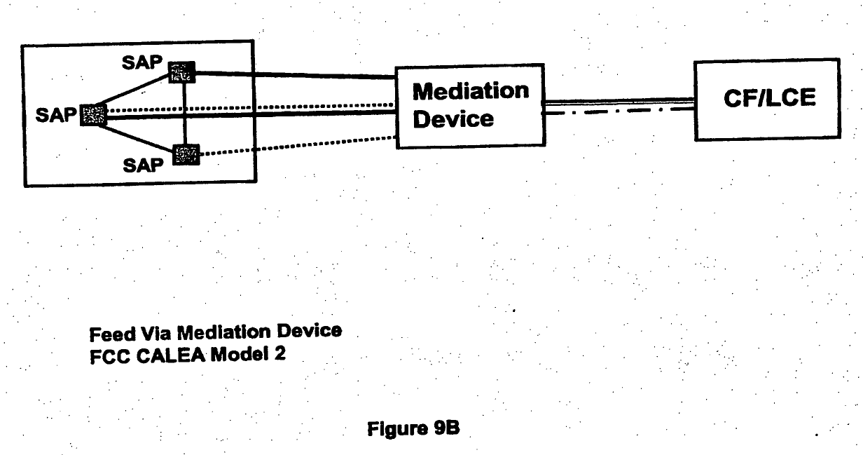

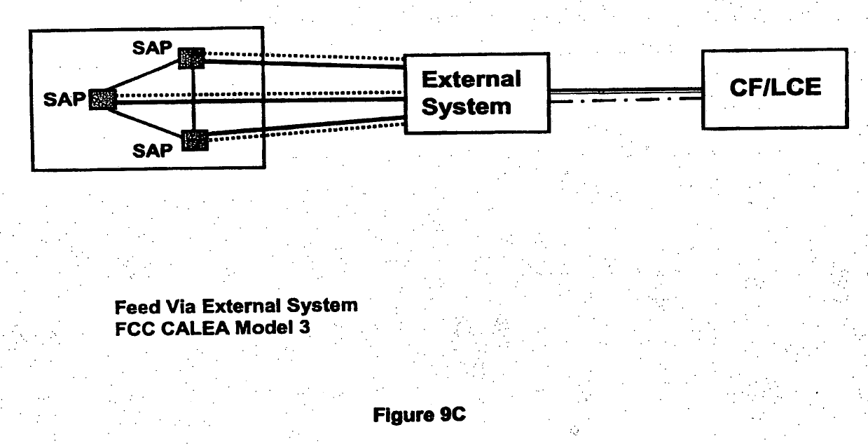

Guidelines FCC04-187 describe three CALEA models for SAP and Lawful Collection Equipment (LCE). These three models are illustrated in FIG. 9A, B and C.

The first model, FIG. 9A, shows is a direct feed from the SAPs to the LCE. The SAPs provide many options and interfaces with the LCE. Each interface must provide CC and CI.

The second model, FIG. 9B, employs a mediation device between the SAPs and the LCE. In this model, each SAP may provide an interface to intercept only CI, or CC, or both. The mediation device is within the managed network provider's domain. There are a few practical implementations, such as Time Warner and Comcast networks.

The third model, FIG. 9C, replaces the mediation device with an external system. The main difference between this model and the previous one is that the external system exists and operates outside of the managed domain. This model presents challenges when DHCP is in use. It will be difficult for the external system to map the targeted device with a dynamic IP address.

The descriptions of these three models lack sufficient details and are insufficient to design and implement CALEA.

When comparing VOP to PSTN Architecture, a number of major differences important to the implementation of CALEA are found. These are described below.

First, the class 5 switch is equivalent to the combination of the Media Gateway (MG) and Call Server (CS), except that the MG and CS are distributed rather than co-located. The class 5 switch uses the common channel signaling (CCS) method for call control. The VoP uses SIP, MGCP, or H.245 for call control. The VoP call control messages look quite different from the CCS messages, however, the types of messages and call flow are very similar in VoP and PSTN. In PSTN, a class 5 switch is owned by one SP, while in VoP, call servers are owned by the SP and Residential media gateways (RMGW) are owned by end-users. CSs and MGs may also belong to a corporation.

Second, the network management unit is similar to what it was in the PSTN, except it might not be collocated with the CS and MG.

Third, a Trunk Gateway (TGW) provides interconnection with the PSTN.

The distributed nature of VOP in comparison to the centralized architecture of PSTN is a key differentiation for CALEA. Since many components are different between PSTN and VOP, in order to implement VOP CALEA, note the analysis of the network and the identification of appropriate components and implementation of SAPs in the VoP network to produce productive surveillance using the VoP functional components as described herein.

In the VoP network, the call control messages and the media are often traveling in independent paths. Unlike the PSTN where CCS messaging determines the media path, the VOP signaling message does not determine the media path. The media path is determined either by the MG and/or the router. However, at the router level, it is difficult to distinguish whether the packets are voice or call control packets.

In the case of peer-to-peer VoP communication, there is no call server involved. The call set-up intelligence resides within the IP devices. This makes CALEA interception even more challenging. The VoP devices often obtain their IP address through DHCP. Dynamic IP address assignment makes it difficult for an IP device to be associated with its IP address.

With reference again to the PacketCable CALEA implementation as shown in FIG. 3, it is the first set of CALEA standards for a VoP network. The Packet Cable security spec is one of the well defined pioneer protocols for VoIP Security and CALEA. It has been implemented and deployed in the field. The PacketCable CALEA model puts Cable Modem Termination System (CMTS) and Call Management Server (CMS) as the Secure Access Points (SAPs). The Trunk Media Gateway (TGW) is also a SAP when interworking with a PSTN. The CMTS is in the role similar to a router.

However, as technologies evolved, there are new requirements for VoIP security. Below is the list of limitations in the PacketCable security.

Security Association (SA) in VOP is between two CPEs (GWs, or IP Phones, or PCs), rather than between two CM/MTA/CMTS.

CPE has the encryption key; CM/MTA/CMTS has no encryption key and other SA parameters.

Security is defined in a transport mode, while in real-life, more IP devices are running in a tunneling mode.

Call control model is defined as client-server (MGCP). It did not address the peer-to-peer (SIP) model.

Firewalls and Network Address Translation is not addressed.

IPSec and internet key exchange (IKE) raise real-time call processing performance concerns.

Public key method, like Kerberos, requires trusty 3rd party for key repository.

Different security mechanisms (protocols, encryption methods & associated parameters, etc.) that need to be supported.

These limitations can be overcome by proper implementation.

The following sections describe five generic VOP CALEA models. It is assumed that the IP devices are the residential gateways. The disclosure teaches a how CALEA works in the first model. For the other four models, only the differences are addressed. Note that each end device may have different CS. To simplify the call flows, only one CS is illustrated.

VOP CALEA—Model 1—Router:

The first model is the router model. It is shown in FIGS. 4A and 4B. In this model, the router and the CS are the SAPs. The router in this model is in a similar role to CMTS in the PacketCable architecture. The router has more information and capabilities to control the targeted IP devices than any other network elements. The router is connected to the public packet network, which makes it more vulnerable for monitoring or interception. Therefore, the router model is recommended.

The disadvantage of this method is that it is difficult to obtain the router information before or during call setup, since the call setup stage does not establish the media path, like PSTN does. Without the router information, such as router's IP address, it is difficult to know which router to monitor. Hence, law enforcement cannot intercept the IP device behind the router.

Stage 1—Subscription:

One challenge for VOP CALEA is the location of the IP device. Some Service Providers (SP) use a fixed media access control (MAC) address of an IP device and user ID and password for initial authentication. It does not matter where the device is located, as long as the device can reach the SP. Assuming user A has VOP subscription to SP-A with his MAC address, user ID, and password. The router that user A will be plugged into is not connected to SP-A, but to an Internet Service Provider (ISP) ISP-A.

Law enforcement informs SP-A and ISP-A of user A under the CALEA act, so CS-A and ISP-A must forward all packets to/from user A to the LCE in the future. But at this moment, SP-A does not know the IP address of user A. If SP-A requires all media to go through its centralized MGW, then the centralized MGW, instead of a router close to user A, can be used for intercepting packets, as indicated in FIG. 5A.

Stage 2—Startup Configuration, FIG. 4B:

When user A is plugged into a router, which is connected to ISP-A, User-A receives a dynamically assigned IP address, assuming 140.1.1.100. Router-A for user A has IP address, for example, 140.1.1.50. The call server for user A at the SP-A is CS-A and the configuration server at the SP-A is Conf-A. For simplicity, the call flows just show CS, not Conf. Note that the SP-A for VOP applications may or may not be the same as the ISP which provides basic Internet Access for router A and the targeted IP device.

Next, user A can login to Conf-A by typing in the URL of Conf-A. All the messages are going through the router. The router is not aware if CALEA act is on user A, but it adds its IP address 140.1.1.50 into the IP packets anyway. Note that this is a proposed new message to obtain the router's IP address. Currently, the router does not add its IP address to the packets that route through it. After Conf-A authenticates user A with its MAC address, login ID, and password, user A is allowed to use services from SP-A. Conf-A sends all the packets to/from user A to DF. DF then replicates the packets to LCE. If security for configuration is needed, Conf-A should be able to Provide the Encryption Key to LCE.

Stage 3—Security Association between an IP Device and Call Server:

If security for signaling message is needed, a Security Association (SA) between user A and CS-A will be needed before exchanging any message. The SA can be on per-call basis or expired at a fixed time interval. In the later case, it must not interrupt an active call during re-negotiating the key. Here, we use Transportation Layer Security (TLS) as the security protocol for signaling. We assume that the SA is established at startup and the SA is expired or renewed at a pre-set interval. CS-A must forward all the TLS messages related to user A to the LCE. The LCE obtains the security key from the message, like user A's IP device would.

When describing the embodiment, it is assumed that the LCE obtains the IP address of router. The LCE knows which router to monitor now. So, LCE requests router A to forward all packets to and from user A.

Stage 4—Call Setup at the Originating Side:

When user A initiates a call setup, as shown in FIG. 4B, his IP device generates an appropriate signaling message to CS-A through the router. Router-A and CS-A replicate all packets to/from user A to the LCE.

Stage 5—Locating Terminating User, Router, and Call Server:

At this moment, the LCE still does not know who the terminator and the terminating CS are until CS-A processes the first call setup request message and sends an INVITE message to the terminating CS-B. The LCE abstracts CS-B information from the second INVITE message. The LCE requests CS-B to comply with CALEA by sending all the messages to/from the terminating user B.

In some cases, intercepting user B is not necessary, as long as the LCE can intercept bi-directional traffic at some network element. However, there are many reasons that we need to intercept at both user A and user B. One reason is that user A might have call features, such as call forwarding, that make it difficult to track down where user A is after call forwarding, therefore, interception of packets to/from user B is helpful.

Also, there will be a SA between user A and user B directly for the media streams. We want to obtain the media security keys for user A and user B. The media key can be created and exchanged in many ways. The paper Sophia Scoggins & Ron Nag, “Security Challenges and Enhancement Methods for VoP Networks”, Embedded Security Seminar, Boston, Sep. 15, 2004, describes different methods in details. Multimedia Internet Keying (MIKEY) and SDP are some options. If the security key is static or manually entered, instead of through a key exchange protocol, the LCE will not be able to obtain the encryption key(s) from the messages. In the case of SDP, the key information can be obtained from the signaling messages, if the signaling messages are in the clear or can be decrypted.

If an incoming call is under CALEA act, the LCE will finds the terminating CS and end user B, as described above. Once the terminating CS starts sending packets to the DF and LCE, the LCE will find the terminating router information and request the terminating router to forward all packets to/from the terminating user.

VoP CALEA Model 2—Centralized Media Gateway (CMG) Model

FIGS. 5A and 5B, illustrate the Centralized MGW (CMG) model of VOP CALEA implementation. The CMGW is the SAP. It is like a security boarder gateway in many commercial products, but terminates not just security association, but also the voice streams. The end devices are usually unaware of the CMGW and think that it is communicating with the remote end device.

The CMGW has the security keys for all media streams. It is the ideal candidate to provide interception. The drawback is that the CMGW will be the traffic bottleneck as illustrated in FIG. 5B.

VOP CALEA Model 3—Distributed Media Gateway Model

FIGS. 6A and 6B illustrate the distributed MGW model of VOP CALEA implementation. In this model, the MGW is the SAP. Since the MGW has the security key, it seems the easiest one to provide CALEA support. However, a Residential MG (RGW) is in the customer premises. If the user is aware of CALEA activities, the user is likely to take any action to stop or interfere with CALEA. Also, the MGW is hidden behind the public packet network and access by an external system is difficult and subject to loss or detection. An MGW is usually cost sensitive with cost-optimized processing power and memory. In order to support CALEA, more processing power and memory will be needed. That puts more burden on the MGW. In conclusion, this model is least favored.

VOP CALEA Model 4—Trunk Gateway Model

FIGS. 7A and 7B illustrate the Trunk Gateway (TGW) model of VOP CALEA implementation. If any party in a call is on the PSTN, while another party is an IP device, then a trunk gateway (TGW) is needed for interworking. The TGW is the SAP. A class 5 switch that controls the call channels linking to the trunk gateway needs to be a SAP for the PSTN side, too. On the VOP side, the CS also needs to be a SAP for the IP device.

The TGW would intercept packets to and from both end points, eliminating the need to use a router as an SAP in addition to the TGW. FIG. 7B illustrates the call flow for the TGW VOP CLAEA. However, a TGW usually just aggregates and multiplexes traffic and has no knowledge of call processing, Network Address Translation (NAT) and firewall. In that case, a router may be added as the SAP, in the manner described above with reference to the router model.

VoP CALEA Model 5—Peer-to-Peer Model

FIGS. 8A and 8B illustrate the peer-to-peer communication model to support CALEA. The peer-to-peer model has intelligence on both end IP devices. There is no call server. Therefore, CALEA cannot be implemented in the manner described above. The SAP must be either on the IP devices or the router. If the SAP is on the IP device, it would be difficult to get the IP device's cooperation, just like the MGW model. If the SAP is on the router, it would be similar to the router model. However, it is more difficult than the router model to get the router information from the IP device before LCE can instruct the router to intercept the CC and CI. Once the router can be identified, there would be fewer components to work with to intercept the CC and CI than the router model. However, if router just forwarded all packets to and from the targeted device to the DF/LCE, it will not be able to distinguish the CC packets from CI packets, like the CS in the other models does.

Implementation of CALEA in a VOP network presents challenges. Security presents the challenge of acquiring the key for decryption. In the absence of security measures, there are still many obstacles to over come in implementing CALEA in VOP. Those challenges can be identified and the methods and functionality can be implemented to overcome the challenges which fall into two categories, with or without security.

VOP CALEA Challenges—Without Security

Challenge 1—Dynamic IP Address Assignment: Law enforcement knows the targeted person to wire-tape his/her communication lines, but does not known the IP address until the person logs in. This is unlike PSTN with predetermined phone number and channels from the subscriber line to the line card at the class 5 switch. Therefore, the LCE has to obtain the IP address of a targeted device in real-time.

Challenge 2—No Fixed Location: In VOP applications, a user can be at any location logging into the VOP network with fixed MAC address, login ID, and password. That means it would be difficult to pre-arrange for CALEA, instead, CALEA will done in real-time.

Challenge 3—Where is the Router: As stated earlier, the router model is the recommended model. The challenge for this model is to find the router. By requiring the router to add the router's IP address to the packets along with path, the router will become known. This is currently not implemented in the router, and will require modification on the router.

Challenge 4—Network Address Translation (NAT): If the route implements Network Address Translation (NAT), then there may be more than one IP device behind the router using the same public IP address. In that case, the DF or LCE will receive more traffic than it needs. It will need a packet filtering function.

Challenge 5—Too Many Signaling Protocols: There are many possible signaling protocols. The LCE needs to support a variety of the signaling protocols. The standards based signaling protocols can be determined by its port number, but one can always use proprietary signaling protocols in a peer-to-peer or un-managed environment. When proprietary signaling protocols are used, it is difficult to intercept. For example, user A may use a known ISP to connect to Internet, but may use a proprietary signaling peer-to-peer protocol to communicate with a remote user. This connection falls under an un-managed peer-to-peer call model.

Challenge 6—Cooperation of User, ISP, and VOP SP: As stated in the earlier section, in a managed VOP network, the internet access is provided by an ISP. The VOP service is provided by a VOP SP. Cooperation from the ISP and VOP SP are needed. In a peer-to-peer or non-managed VOP model, cooperation from the targeted user IP device is needed. This level of cooperation is difficult to achieve.

VOP CALEA Challenges—With Security

Security includes authentication and encryption. In CALEA, authentication is not a concern. CALEA is only concerned about the encryption/decryption key. The challenge is in obtaining the encryption/decryption key.

Challenge 1—How to obtain encryption key: When the VOP security feature is enabled, the most important question is how to obtain the encryption key. If there is no key exchange occurring during the stage of establishing a SA, then both ends are using static or manual keying. It becomes impossible for the LCE to decrypt the packets. If TLS is used for encrypting the media key exchange (which could use DSP or other signaling messages), then the LCE is most likely to obtain the key from the TLS encrypted signaling messages as long as it has access to the TLC pre-master secret which allows it to decrypt the TLS communication. If the key exchange method for media is through SDP in unencrypted signaling messages and the keying protocol is symmetric, then it would be easy to obtain the key and decrypt the messages. If the key exchange method is using a public key method and the encryption is not symmetric, then there is no way to decrypt the packets unless the private key is known. The latter is not a likely scenario since public key encryption of realtime message traffic requires enormous computing power and can be extremely expensive and impractical to implement.

Challenge 2—Too Many Security Protocols: There are many possible security protocols. The standards based security mechanisms can be IPSec, SSL/TLS, SHTTP, SSH, and more. The key exchange protocols can be Internet Security Alliance (ISA), IKE, embedded within TLS, MIKEY, through SDP, etc. Even within each key exchange protocol, there can be many different methods—five different Diffie-Hellman (DH) groups, public keying, RSA, symmetric key, hybrid keying, etc. The LCE needs to support all security protocols in order to intercept during real-time call processing. If user A and B decide to use proprietary security protocols, then there is no way to intercept and interpret the messages.

VOP CALEA Solutions

Solution 1—Centralized CS and MG

The SIP proxy server is used to find out the remote end device in order to establish a connection. Once the remote IP address is known, the call control messages can go directly between two end points, if no call feature is involving a SIP proxy server. Some call features, such as call transfer and call forwarding, can be implemented either on the network or on the end devices, depending on VOP SP. If the call features are based on the end devices, then the proxy server may not be aware of the call features at all. That means LCE may not be able to intercept the remaining call. If all signaling messages must go through the VOP SP's CS, that will make interception easier.

A call server is not involved in the media stream. The media path is determined by the routers and the end devices. If all voice streams must go through the VOP SP's centralized MG (CMG), then interception would be easy.

Solution 2—Add Router Info to the IP Header

The IPv4 header does not provide a field to add a list of routers along the path. It is proposed to add a router header option or use a payload field to provide router information. Every time a packet passes by a router from a local device, the router will add its IP address to the optional router header or payload. There would be more than one router along the path. Theoretically, any router can be used for intercepting packets that along its path, however, the router closest to the targeted device will be the best choice. So, if a router sees that there is no route information, it will add its IP address to the IP Header or payload. If the first 4 bytes of payload are in use, such as IPSec Authentication Header (AH) and Encapsulation Security Protocol (ESP), then router info should be added after those additional info fields.

Packets from the same end devices may go through different paths, and one may find more than one router is used for an end device. However, statistics demonstrate that a majority of packets between two end points go through the same path, unless the path is saturated. If the DF sees more than one route info is added to different packets, all routers in the route info should be intercepted. Once the router is identified, the LCE may want to send a message to stop the router from adding its IP address to the future packets.

The advantage of this approach is that it is very simple to implement. And the routers need not know what signaling or security protocols are in use. The disadvantage of this approach is that it adds too much overhead to the overall traffic, even after we knew the IP address of router. As a result, performance degradation can be expected. Also, packets may go through different routers. Intercepting different routers in real-time may be needed.

Solution 3—Add Route Record to the Signaling Message Header

This approach is to add the route record to the signaling message header. The router first checks the port number of packets. Only if the port number indicates that the packets are signaling packets, the router will modify the header. The drawback of this approach is that the routers need to know the applications. This approach is similar to NAT application algorithm (ALG) to by-pass the NAT unit. If the signaling messages are encrypted, the router has no security key to decrypt the messages; thus this approach will not work.

Solution 5—Obtain Router Info from DHCP of ISP

When the targeted device initially plugged into a router, it needs to obtain its IP address from the DHCP server of an ISP. The DHCP server knew the IP addresses of the router and of the device. However, the mobility of IP device will make it difficult to determine where the IP device will be plugging into which device.

Solution 6—Enforce Security Key Info in SDP

How to obtain the security key has been a big challenge. We proposed the security key information be included in SDP when CALEA act is in effect. The disadvantage of this approach is that user can easily modify the packets to not include the security key info in SDP. Another concern is that if the security key is obtained by the wrong person, it can do more harm than no security at all.

Solution 7—Enforce Security Protocols

Similar to the previous approach, the standard bodies and ISP must enforce certain security protocols be adopted. This reduces the complexity of security protocols to be supported tremendously. For example, the SIP community endorses TLS for security. The SIP community needs to further refine the authentication and encryption protocols to be supported.

Solution 8—Register at a Trusted 3rd Party with All Security Keys

Currently, some trusted 3rd party organizations, like Verisign, are providing certifications for key registrations. If CALEA requires all end devices with a security feature to register their security keys with a trusted 3rd party that would make interception much easier. However, there will be many opponents about this resolution, as if the keys fall into the wrong hands, the damage would be significant.

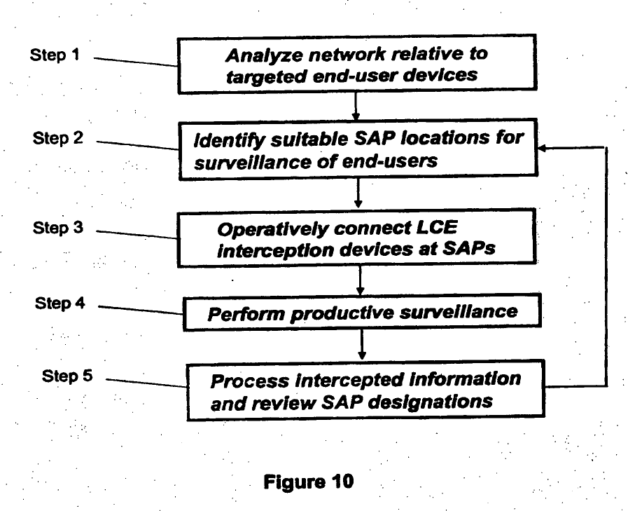

One or more embodiments can comprise a procedure for electronic surveillance of Voice over Internet Protocol (VoIP) messages in Voice over Packet (VoP) networks when end-to-end encryption/decryption and network address translation (NAT) are being utilized by an end user of the network. As shown in FIG. 10, an analysisprocedure comprises the steps of analyzing the network relative to one or a plurality of targeted end-user devices (Step 1), to identify suitable surveillance access points (SAPs) for electronic signal interception based on the system configuration and operation parameters of the network (Step 2), operatively connecting suitable interception devices to the network at the suitable surveillance access points (Step 3), performing productive electronic surveillance by intercepting electronic packet messages via the interception devices (Step 4) and performing surveillance processing of intercepted packet messages to determine additional suitable access points (Step 5).

In a first exemplary embodiment, FIG. 4A depicts a managed VoP network (10), administered by a service provider, wherein an end-user device (11) (either a PC (11A) or a telephone (11B)) may place or receive packet-based telephone calls either within the network, or alternatively, through the network to a public switched telephone network (PSTN) (12). In the first embodiment, Step 1 of the analysis procedure (analysis of the network) reveals that user device 11 is connected to network 10 via a media gateway (13), an access network (14) and finally an edge router (15). Step 1 also reveals that network 10 further comprises the VoP-capable devices of a call server (16), an audio server (17) and a trunk gateway (31). Finally, the procedure reveals that the entire VoP network 10 is being managed by a network management system (18). Note that calls generally involve two or more parties with two or more end-user devices, gateways and access networks. These additional devices, gateways and networks are not shown for clarity.

The nature of the targeted end-user device 11 may or may not be known as a result of the Step 1 analysis. Similarly, the nature of any end-user encryption and whether or not NAT is in place may be unknown. Step 1 provides the first step of an iterative procedure for helping to determine these facts through surveillance.

Also as shown in FIG. 4A, the service provider for network 10 is obligated by the Communications Assistance for Law Enforcement Act (CALEA) to provide a known Delivery Function (DF) (19) within its network. The DF performs the services of intercepting without altering packets at network SAPs and then replicating and facilitating delivery of the packets to a known collection function (CF) utilizing Law Enforcement Agency Collection Equipment (LCE), collectively referred to as (CF/LCE) (20). The LCE are voice signal call information (CI) and call message call content (CC) packet interception devices which are used to intercept CI and CC transmissions originating from and being routed to user device 11. The CF/LCE exist within the domain of and are under the control of a designated law enforcement agency (LEA).

As a result of the analysis of the network of the first embodiment performed during procedure Step 1 above, router 15 and call server 16 are identified as suitable SAPs during procedure Step 2. The precise nature of the Step 1 analysis and Step 2 SAP identification is beyond the scope of this discussion. Both steps are performed internal to the LEA in cooperation with the service provider. The network analysis and identification of SAPs is based on LEA assumptions regarding the nature and use of the targeted user device 11, the media gateway 13, the access network 14 and the physical and operational features of network 10.

In Step 3 of the procedure, router 15 and call server 16, collectively, exemplary SAP devices 15/16, are configured by the service provider as part of DF 19 to permit interface with CF/LCE 20. Once operational, the CF/LCE device operates in conjunction with the SAP devices to facilitate productive surveillance during Step 4 of the procedure.

In this embodiment, productive surveillance comprises intercepting VoP call set-up signals (CI) originating from user device 11 as early as possible during security association (SA) set up. FIG. 4B depicts a call flow for this exemplary embodiment. It begins with a call originating at a end-user device, shown as Customer Premises Equipment (CPE-A) (which in this example is end-user device 11), and involving a media gateway (MG-A) (which in this example is media gateway 13), an edge router (ER-A) (which in this example is router 15), the DF 19 and the CF/LCE 20, collectively shown as DF/LCE 20 in FIG. 4B, call server (CS) 16, another edge router (ER-B) 21, another media gateway (MG-B) 22 and another end-user device (CPE-B) 23.

As shown in FIG. 4B, the surveillance process can begin when the end-user device 11 goes “off-hook” 24. The DF, in association with the CF/LCE, requests call set-up information (CI) from the call server 16. This is represented by CI Req 25. As digits 26 are entered, the media gateway 13 places an invitation 27 to the call server 16 in accordance with known techniques. The invitation can be an INVITE, a CONNECT, a SETUP, or the like. As various call set up information (CI) is exchanged between the call server and the media gateway, that CI is replicated at the call server location and forwarded via the DF to CF/LCE 20 for analysis by the LEA. This is represented by RCI 28.

Call set-up information continues to transmit between the various network components in accordance with known techniques until the VoP call is set up. At each involvement of the call server 16, the replicated CI is transmitted in an associated RCI to CF/LCE 20. The nature of the RCI information received by the LEA during this process depends on the call set-up protocols at work, the encryption algorithm (if any) and the application, and is beyond the scope of this discussion. However, it is the intended by one or more embodiments that surveillance performed during this embodiment would intercept packets passing between MG-A 13 and MG-B 22 and call server 16 which contain information in the headers and data fields regarding who the message is going to and from as well as the IP address of any proxy servers being used. In accordance with one or more embodiments, the encryption protocol and keys (if any) for the follow-on voice message (CC) stream, as may be contained for example in the early CI packet payloads, can be intercepted and/or utilized to intercept and decrypt that voice message stream.

In the illustrated example, once call set-up is complete, or once sufficient information is collected by CALEA, the DF, in association with the CF/LCE, requests call content (CC) from router 15. The request for call content is represented by CC Req 29. The CC Req 29 can be transmitted when sufficient information (for example, IP address and port number) is collected by CALEA, which may be as early as after the invitation or the first RCI is received, after the final RCI in a series is received, or any time in between. On the other hand, the CC Req 29 can be transmitted after an ACK is received, to avoid attempting surveillance of a call that is not connected.

If previous Step 1 analysis has indicated that ER-B 21 should be identified as a SAP, then the DF can make a CC Req 29′ from ER-B as well. As the call transpires, the two edge router SAPs ER-A15 and ER-B 21 can replicate call content (CC) packets which are passed to the CF/LCE for analysis. Although only two RCC packets 30 and 30′ are illustrated, they are representative of any number of RCC packets that can be passed.

Call content can continue to transmit between the two end-user devices until the VoP call ends. At each involvement of edge routers ER-A 15 and ER-B 21, an associated RCC packet is transmitted to CF/LCE 20 for analysis. The nature of the RCC information received by the LEA during this process depends on the call protocols at work, the encryption algorithm (if any) and the application, and is beyond the scope of this discussion. However, it is the intended that surveillance performed during this embodiment would intercept targeted end-user packets passing between edge routers ER-A 15 and ER-B 21. These packets may contain information which is able to be decrypted by using the encryption protocol and key intercepted above and which can lead to Step 5, better analysis of the end-user environment relative to network 10 and to better identification of suitable SAPs.

In a second exemplary embodiment, FIG. 5A depicts a managed VoP network (100), administered by a service provider, wherein an end-user device (111) (either a PC (111A) or a telephone (111B)) may place or receive packet-based telephone calls either within the network, or alternatively, through the network to a public switched telephone network (PSTN) (112). In the second embodiment, Step 1 of the analysis procedure (analysis of the network) reveals that the end-user device 111 is connected to network 100 via a media gateway (113), an access network (114) and finally an edge router (115). Step 1 also reveals that network 100 further comprises the VoP-capable devices of a call server (116), a centralized media gateway (117) and a trunk gateway (131). Finally, the procedure reveals that the entire VoP network 100 is being managed by a network management system (118). Note that calls generally involve two or more parties with two or more end-user devices, gateways and access networks. These additional devices, gateways and networks are not shown for clarity.

The nature of the targeted end-user device 111 may or may not be known as a result of the Step 1 analysis. Similarly, the nature of any end-user encryption and whether or not NAT is in place may be unknown. Step 1 provides the first step of an iterative procedure for helping to determine these facts through surveillance.

Also as shown in FIG. 5A, the service provider for network 100 is obligated by the Communications Assistance for Law Enforcement Act (CALEA) to provide a known Delivery Function (DF) (119) within its network. The DF performs the services of intercepting without altering packets at network SAPs and then replicating and facilitating delivery of the packets to a known collection function (CF) utilizing Law Enforcement Agency Collection Equipment (LCE), collectively referred to as “CF/LCE” (120). The LCE are voice signal call information (CI) and call message call content (CC) packet interception devices which are used to intercept CI and CC transmissions originating from and being routed to user device 111. The CF/LCE exist within the domain of and are under the control of a designated law enforcement agency (LEA).

As a result of the analysis of the network of the second embodiment performed during Step 1 above, call server 116 and centralized media gateway 117 are identified as suitable SAPs during procedure Step 2. The precise nature of the Step 1 analysis and Step 2 SAP identification is beyond the scope of this discussion. Both steps are performed internal to the LEA in cooperation with the service provider. The network analysis and identification of SAPs is based on LEA assumptions regarding the nature and use of the targeted user device 111, the media gateway 113, the access network 114 and the physical and operational features of network 100.

In Step 3 of the procedure, call server 116 and centralized media gateway 117, collectively, exemplary SAP devices 116/117, are configured by the service provider as part of DF 119 to permit interface with CF/LCE 120. Once operational, the CF/LCE device operates in conjunction with the SAP devices to provide surveillance of communications during Step 4 of the procedure.

In this second embodiment, surveillance comprises intercepting VoP call set-up signals (CI) originating from user device 111 during security association (SA) set up, for example as early as possible. FIG. 5B illustrates a call flow for this exemplary embodiment. It begins with a call originating at an end-user device, shown as Customer Provided Equipment (CPE-A) (which in this example is end-user device 111), and involving a media gateway (MG-A) (which in this example is media gateway 113), an edge router (ER-A) (which in this example is router 115), the centralized media gateway 117, the DF and the CF/LCE, collectively shown as DF/LCE 120 in FIG. 5B, call server (CS) 116, another edge router (ER-B) 121, another media gateway (MG-B) 122 and another end-user device (CPE-B) 123.

As shown in FIG. 5B, the surveillance process begins for example when the end-user device 111 goes “off-hook” 124. The DF, in association with the CF/LCE, requests call set-up information (CI) from call server 116. This is represented by CI Req 125. As digits 126 are entered, media gateway 113 places an invitation 127 to the call server 116. As call set up information (CI) is exchanged between the call server and the media gateway, that CI is replicated at the call server location and forwarded via the DF to CF/LCE 120 for analysis by the LEA. This is represented by RCI 128.

Call set-up information continues to transmit between the various network components until the VoP call is set up. At each involvement of call server 116, associated RCI is transmitted to CF/LCE 120. The nature of the RCI information received by the LEA during this process depends on the call set-up protocols at work, the encryption algorithm (if any) and/or the application, and is beyond the scope of this discussion. However, it is the intended that surveillance performed during this embodiment would intercept packets passing between MG-A 113 and MG-B 122 and call server 116 which contain information in the headers and data fields regarding who the message is going to and from, optionally together with the IP address of any proxy servers being used. Further, according to one or more embodiments, the encryption protocol and keys (if any) for the follow-on voice message (CC) stream, as may be contained in the early CI packet payloads, can be intercepted and utilized to intercept and decrypt that voice message stream.

Once call set-up information is sufficiently complete, the DF, in association with the CF/LCE, requests call content (CC) from centralized media gateway 117. This is represented by CC Req 129. As the call transpires, the centralized media gateway replicates call content (CC) packets which are passed to the CF/LCE for analysis. This is shown as RCC 130.

Call content continues to transmit between the two end-user devices until the VoP call ends. At each involvement of centralized media gateway 117, associated RCC is transmitted to CF/LCE 120. The nature of the RCC information received by the LEA during this process depends on the call protocols at work, the encryption algorithm and the application, and is beyond the scope of this discussion. However, it is the intended that surveillance performed during this embodiment would intercept targeted end-user packets passing between edge routers 115 and 121. One or more embodiments provide that such packets can contain information which is able to be decrypted by using the encryption protocol and key intercepted above and which can lead to Step 5 discussed above, better analysis of the end-user environment relative to network 100 and to better identification of suitable SAPs.

In a third exemplary embodiment, FIG. 6A depicts a managed VoP network 200, administered by a service provider, wherein an end-user device 211 (either a PC 211A or a telephone 211B) may place or receive packet-based telephone calls either within the network, or alternatively, through the network to a public switched telephone network (PSTN) 212. In the second embodiment, Step 1 of the analysis procedure (analysis of the network) reveals that user device 211 is connected to network 200 via a media gateway 213, an access network 214 and finally an edge router 215. Step 1 also reveals that network 200 further comprises the VoP-capable devices of a call server 216, an audio server 217 and a trunk gateway 231. Finally, the procedure reveals that the entire VoP network 200 is being managed by a network management system 218. Note that calls generally involve two or more parties with two or more end-user devices, gateways and access networks. These additional devices, gateways and networks are not shown for clarity.

The nature of the targeted end-user device 211 may or may not be known as a result of the Step 1 analysis. Similarly, the nature of any end-user encryption and whether or not NAT is in place may be unknown. Step 1 provides the first step of an iterative procedure for helping to determine these facts through surveillance.

Also as shown in FIG. 6A, the service provider for network 100 is obligated by the Communications Assistance for Law Enforcement Act (CALEA) to provide a known Delivery Function (DF) 219 within its network. The DF performs the services of intercepting without altering packets at network SAPs and then replicating and facilitating delivery of the packets to a known collection function (CF) utilizing Law Enforcement Agency Collection Equipment (LCE), collectively referred to as (DF/LCE) 220. The LCE are voice signal call information (CI) and call message call content (CC) packet interception devices which are used to intercept CI and CC transmissions originating from and being routed to user device 211. The CF/LCE are expected to exist within the domain of and are under the control of a designated law enforcement agency (LEA).

As a result of the analysis of the network of the third embodiment performed during procedure Step 1 above, media gateway 213 and call server 216 are identified as suitable SAPs during procedure Step 2. The precise nature of the Step 1 analysis and Step 2 SAP identification is beyond the scope of this discussion. Both steps are performed internal to the LEA in cooperation with the service provider. The network analysis and identification of SAPs is based on LEA assumptions regarding the nature and use of the targeted user device 211, the media gateway 213, the access network 214 and the physical and operational features of network 200.

In Step 3 of the procedure, media gateway 213 and call server 216, collectively, exemplary SAP devices 213/216, are configured by the service provider as part of DF 219 to permit interface with CF/LCE 220. In this embodiment, configuration of the media gateway, which may physically exist on the end-user's premises, can occur via factory-installed hardware or software (for example, government regulated in alliance with CALEA) or via a configuration software sent to the media gateway by the service provider, or a combination of the above. Once operational, the CF/LCE device operates in conjunction with the SAP devices to facilitate productive surveillance during Step 4 of the procedure.

In this third embodiment, productive surveillance comprises intercepting VoP call set-up signals (CI) originating from user device 211 as early as possible during security association (SA) set up. FIG. 6B depicts a call flow for this exemplary embodiment. It begins with a call originating at an end-user device, shown as Customer Provided Equipment (CPE-A) (which in this example is end-user device 211), and involving a media gateway (MG-A) (which in this example is media gateway 213), an edge router (ER-A) (which in this example is router 215), the DF and the CF/LCE, collectively shown as CFJ/LCE 220 in FIG. 6B, call server CS 216, another edge router (ER-B) 221, another media gateway (MG-B) 222 and another end-user device (CPE-B) 223.

As shown in FIG. 6B, the surveillance process begins, for example, when end-user device 211 goes “off-hook” 224. The DF, in association with the CF/LCE, requests call set-up information (CI) at some point from call server 216. This is represented by CI Req 225. As digits 226 are entered, media gateway 213 places an invitation 227 to the call server 216. As CI is exchanged between the call server and the media gateway, that CI is replicated at the call server location and forwarded via the DF to CF/LCE 220 for analysis by the LEA. This is represented by RCI 228.

Various call set-up information continues to transmit between the various network components until the VoP call is set up. At each involvement of call server 216, associated RCI is transmitted to CF/LCE 220. The nature of the RCI information received by the LEA during this process depends on the call set-up protocols at work, the encryption algorithm (if any) and/or the application, and is beyond the scope of this discussion. However, it is the intended that surveillance performed during this embodiment would intercept packets passing between MG-A 213 and MG-B 222 and call server 216 which contain information in the headers and data fields regarding who the message is going to and from, and optionally the IP address of any proxy servers being used. Also, according to alternative embodiments, the encryption protocol and keys for the follow-on voice message (CC) stream, for example as may be contained in the early CI packet payloads, can be intercepted and utilized to intercept and decrypt that voice message stream.

Once call set-up information is sufficiently complete, the DF, in association with the CF/LCE, can request call content (CC) from media gateway MG-A 213. This is represented by CC Req 229. If previous Step 1 analysis has indicated that media gateway MG-B 222 should be identified as a SAP, then the DF would make a CC Req 229′ from MG-B 222 as well. As the call transpires, media gateways MG-A 213 and MG-B 222 replicate call content (CC) packets which are passed to the CF/LCE for analysis. The two illustrated RCC packets 230 and 230′ are representative of any number of RCC packets that are passed to the CF/LCE.

Call content continues to transmit between the two end-user devices until the VoP call ends. At each involvement of either media gateway MG-A 213 and MG-B 222, an associated RCC is transmitted to CF/LCE 220. The nature of the RCC information received by the LEA during this process depends on the call protocols at work, the encryption algorithm and/or the application, and is beyond the scope of this discussion. However, it is the intended that surveillance performed during this embodiment would intercept targeted end-user packets passing between media gateways MG-A 213 and MG-B 222. The targeted end-user-packets may contain information which is able to be decrypted by using the encryption protocol and key intercepted above and which leads to Step 5 of the procedure, better analysis of the end-user environment relative to network 200 and to better identification of suitable SAPs.

The fourth exemplary embodiment is very similar to the first embodiment, with the exception that if a VoP caller is calling to an end-user within the PSTN, analysis of the network would reveal that trunk gateway 31 should also be identified as a SAP. FIG. 7A depicts the network 10 of the first embodiment with trunk gateway 31 so identified. In this embodiment, because the trunk gateway usually does not participate in call processing, edge routers 15 and 21 may remain as SAPs. In addition, a PSTN Class 5 switch that controls the call channels linking to the trunk gateway (not shown) may be added as a SAP.

As shown again in FIG. 7B, call set-up proceeds similar to the first exemplary embodiment until complete. Requests for call content (CC Req) would then be made from DF 19 to the trunk gateway 31 CC Reqs 329.

As the call transpires, media gateway MG-A 13 replicates call content (CC) packets which are passed to the CF/LCE for analysis. These are represented by RCC 330.

Finally, FIG. 8A depicts a fifth exemplary embodiment in which Step 1 analysis has shown a general VoP network with edge routers ER-A 415 and ER-B 415′, with DF 419 and external CF/LCE 420. End-user Session Initiation Protocol-capable internet protocol telephones 411 and 411 ′ are operating across the network in a peer-to-peer arrangement. In this embodiment, there is no call server, since packets are routed directly between end-users by the routers.

The routers are chosen as the SAPs in Step 2 to which CF/LCE devices are operatively connected in Step 3. An exemplary call flow for this arrangement is illustrated in FIG. 8B. As with the previous embodiments, the productive surveillance of Step 4 comprises attempting to intercept VoP call packets early in the call, during security association negotiation between the two end-users. During the initial stages of the call, the DF initiates CI requests CI Req) 425 and 425′ to both edge routers ER-A 415 and ER-B 415′. Then as the remainder of the call is set-up, RCI can be relayed from the two edge routers ER-A 415 and ER-B 415′ back to the CF/LCE. Once the two-way trip is sufficiently established between the end-users, the DF/LCE 420 can transmit a CC Req 429 to edge router A ER-A 415, and another CC Req 429′ to edge router B ER-B 415′. The routers can then transmit RCC 430, 430′ from the routers back to the CF/LCE. If, during call set-up, the LEA has been able to ascertain the sender's and receiver's addresses, it will be able to process the intercepted CC packets for surveillance. Accordingly, one or more embodiments provides that the VOP network is a peer-to-peer network and the network infrastructure device is an edge router; and responsive to a call content request (CCReq) specifying the particular target, and responsive to receiving communications at least one of to and from the particular target, the communications are forwarded to the LEA collection device.

Furthermore, accordingly, one or more embodiments provides that the VOP network is a peer-to-peer network; at least one of a signaling security information and a media security information are identified from a sequence of communications; and the at least one signaling security information and media security information exchanged with the particular target are forwarded to the LEA collection device.

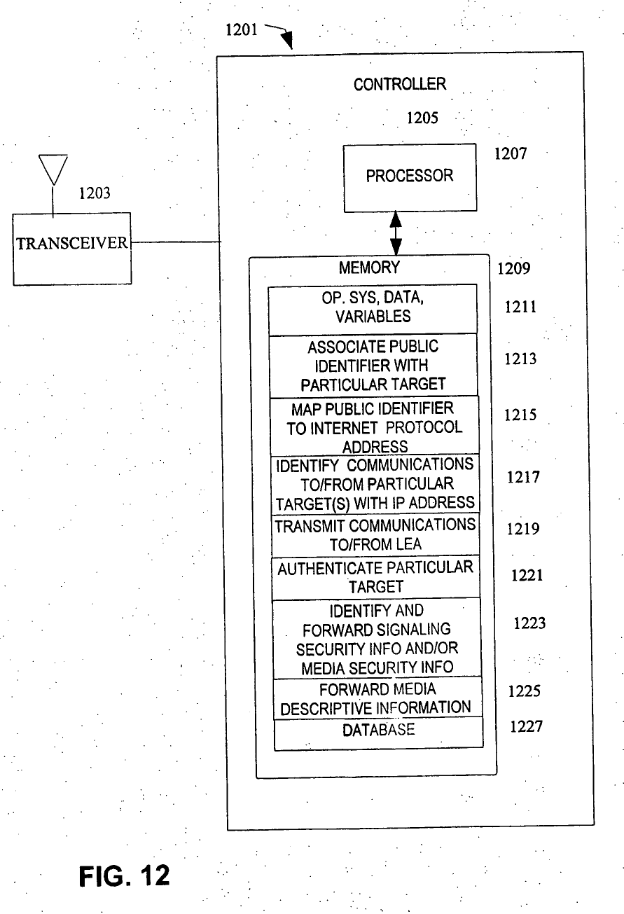

Referring now to FIG. 12, a block diagram illustrating portions of an exemplary network infrastructure device 1201 in accordance with various exemplary embodiments will be discussed and described. The network infrastructure device can be any of the following devices, or variations and/or equivalents: an edge router, a centralized media gateway, a session border controller, a media gateway, a trunk gateway, a media box, or a call server. With respect to the exemplary call flows provided in FIG. 4B, the network infrastructure devices are the edge routers ER-A 15, ER-B 21, and the call server CS 16. With respect to the exemplary call flows provide in FIG. 5B, the network infrastructure devices are the centralized media gateway CMG 117, and the call server CS 16. With respect to the exemplary call flows provide in FIG. 6B, the network infrastructure devices are the media gateways MG-A 213, MG-B 222 (also referred to as “media boxes”), and the call server CS 16. With respect to the exemplary call flows provide in FIG. 7B, the network infrastructure devices are the trunk gateway TG 31 and the call server CS 16. With respect to the exemplary call flows provide in FIG. 8B, the network infrastructure devices are the edge routers ER-A 15, ER-B 21. More particularly, the network infrastructure device can be operating as an edge router in an internal communication session, a centralized media gateway or a session border controller in an external communication session, a media gateway where the media gateway is operably connected to a media box, a trunk gateway when communications are between the VOP network and a PSTN, or a media box where the VOP network is peer-to-peer.

The infrastructure device 1201 may include a transceiver 1203 and one or more controllers 1205. The transceiver 1203 is representative of a combination of any number of transmitters and/or receivers. The controller 1205 may include a processor 1207, a memory 1209, and other optional components which will be well understood to those in this field.

The processor 1207 may be, for example, one or more microprocessors and/or one or more digital signal processors. The memory 1209 may be coupled to the processor 1207 and may comprise a read-only memory (ROM), a random-access memory (RAM), a read/write flash memory, a programmable ROM (PROM), and/or an electrically erasable read-only memory (EEPROM). The memory 1209 may include multiple memory locations for storing, among other things, an operating system, data and variables 1211 for programs executed by the processor 1207; computer programs for causing the processor to operate in connection with various functions such as associating 1213 a public identifier with a particular target, mapping 1215 the public identifier to the internet protocol address, identifying 1217 communications to/from particular target(s) with IP address, transmitting 1219 communications to/from the LEA, authenticating 1221 a particular target, identifying and forwarding signaling security information and/or media security information 1223, and forwarding media descriptive information 1225; and a database 1227 of various information used by the processor 1207. The computer programs may be stored, for example, in ROM or PROM and may direct the processor 1207 in controlling the operation of the network infrastructure device 1201. Each of these computer programs is discussed by way of example below.

The processor 1207 may be programmed for associating 1213 a public identifier with a particular target. For example, the processor 1207 can receive a call setup information request (CIReq) specifying a particular target. Such a request could be received, for example, over the transceiver 1203, or could be the result of locally generated input. It is expected that the CIReq specifies the particular target. Accordingly, the processor 1207 can determine one or more public identifiers associated with the particular target. This can be done for example via a look-up table, a hash table, or the like. The particular target provided in the CIReq can be a public identifier, in which event no further determination is needed.

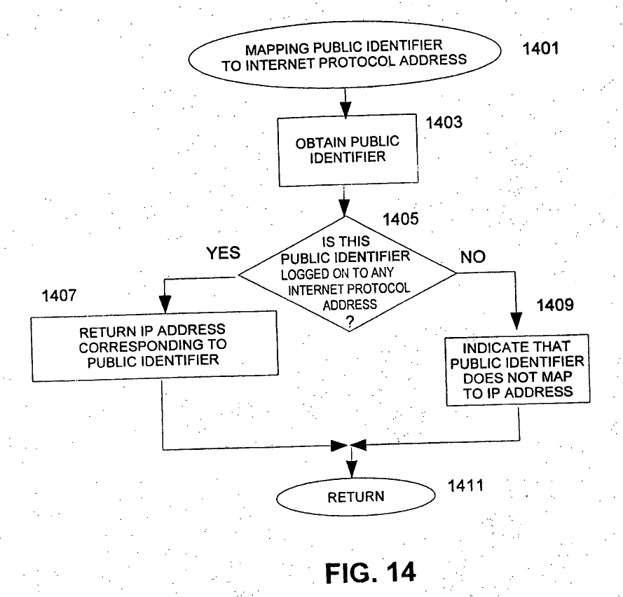

Also, the processor 1207 may be programmed for mapping 1215 the public identifier to the internet protocol (IP) address. It should be noted that the IP address for a particular public identifier is not fixed in a VOP network, as a user device can be connected at various IP addresses. Therefore, it is incumbent upon the VOP network to provide a method for locating public identifiers which are using the VOP network. FIG. 14 provides an exemplary method for mapping the public identifier to the IP address. The IP address can be provided by, for example, a routable uniform resource identifier (URI), P_asserted_header, and/or P_associated_ID, variations, and/or equivalents in various other protocols. Other methods are possible and are intended to be included in the scope. In accordance with one or more embodiments, the mapping 1215 is responsive to a call content request (CCReq).

Optionally, where the request from the LEA identifies a primary target and a secondary target, the public identifiers can be associated for both targets, and both public identifiers can be mapped to IP addresses. Accordingly, one or more embodiments provides, when the CIReq specifies a secondary target in connection with the particular target, and responsive to receipt of the CIReq specifying a secondary target in connection with the particular target, associating a secondary public identifier with the secondary target, mapping the secondary target to a secondary internet protocol (IP) address responsive to the communications, and identifying communications between the particular target and the secondary target, wherein the communications that are transmitted to the LEA collection device are between the particular target and the secondary target.

Furthermore, the processor 1207 may be programmed for identifying 1217 communications to/from particular target(s) with IP address. For example, various communication protocols call for information identifying the IP address to be included in the call set up information and the header or envelope of the call content. Thus, the processor 1207 can forward only those communications that correspond to the requested particular target, and can avoid forwarding other communications.

Optionally, where the request from the LEA identifies a primary target and a secondary target, communications between those two targets can be identified, so that the processor 1207 can avoid forwarding other communications.

The processor 1207 also may be programmed for transmitting 1219 communications to/from the LEA. For example, the LEA can communicate via communication packets with the processor 1207, where the communication packets are received and/or transmitted on the transceiver 1203 in accordance with standard techniques. If desired, an alternative embodiment can provide for a dedicated connection (not illustrated) to LEA, which would transmit/receive communications in accordance with known techniques. Communications to/from the LEA can alternatively be provided via a communications port (not illustrated) connected to another network, for example, a local area network, intranet, or the Internet.

Accordingly, one or more embodiments provides for a network infrastructure device in a voice over packet (VOP) network. The network infrastructure device includes a transceiver operable to transmit and receive communications over at least a portion of a VOP network; and a processor cooperatively operable with the transceiver, and configured to facilitate, responsive to receipt of a call setup information request (CIReq) specifying a particular target, associating a public identifier with the particular target, and mapping the public identifier to an internet protocol (IP) address responsive to a communication; identifying communications to/from the particular target with the IP address; and responsive to receiving communications at least one of to and from the IP address, transmitting the communications to a law enforcement agency (LEA) collection device.

Optionally, the processor 1207 can be provided with additional functions and/or enhancements, such as the illustrated authentication 1221 function, signaling and/or media security forwarding function 1223, and/or media descriptive function 1225. These are described in more detail below.

One or more alternative embodiments can provide that the processor 1207 authenticates 1221 a particular target. For example, it may be desirable to only forward communications to/from a particular target after the particular target is authenticated. This can provide an additional measure of assurance that the communications are indeed associated with the designated target. For example, the target can be authenticated by device identification (such as a MAC address, device ID, or the like) and/or user identification (for example, public identifier, P_asserted_ID, P_associated_ID, password, or the like). Many methods for authenticating are known and are therefore not discussed here in further detail. Any desired method for authenticating can be implemented. Accordingly, one or more embodiments provide that the communications to/from the particular target are forwarded only after the particular target is authenticated. Also, one or more embodiments provide that the particular target is authenticated by at least one of a device identification and a subscriber identification.

In accordance with one or more alternative embodiments, the processor 1207 also may be programmed for identifying and forwarding signaling security information and/or media security information 1223. Communications on the VOP network can contain signaling security information, including an identification of a security protocol (for example, IPSec or TLS); and/or media security information, including security key exchange method (for example, IKE, ISA, public key technology (PKT), shared key technology, and the like). Accordingly, one or more embodiments include forwarding at least one of a signaling security information and a media security information corresponding to the particular target to the LEA collection device. Furthermore, one or more embodiments include providing media information describing the media of the communications (for example, the port number, CODEC type, bandwidth, and/or communication control information and the like) associated with the particular target to the LEA collection device. Accordingly, one or more embodiments provide for identifying at least one of a signaling security information and a media security information from a sequence of communications, and forwarding the at least one of signaling security information and media security information exchanged with the particular target to the LEA collection device.

Alternatively, the processor 1207 may be programmed for forwarding media descriptive information 1225, including for example information describing the media of the communications to/from the particular target. Accordingly, one or more embodiments provides for providing media information describing the media of the communications at least one of to and from the particular target to the LEA collection device. The information associated with a communication session can be forwarded to the LEA so that the LEA can better decipher the communications.

Accordingly, one or more embodiments provide for a computer-readable medium comprising instructions for execution by a computer, the instructions including a computer-implemented method for providing surveillance of communications on a voice over packet network. Further, one or more embodiments provide for (A) receiving a call setup information request (CIReq) specifying a particular target, and responsive thereto, associating a public identifier with the particular target and mapping the public identifier to an internet protocol (IP) address; (B) identifying communications at least one of to and from the particular target with the IP address; and (C) responsive to receiving communications at least one of to and from the IP address, transmitting the communications to a law enforcement agency (LEA) collection device.

Also illustrated is the database 1127 of various information used by the processor 1207. The database 1227 is provided for local storage of information. For example, the database can be used for storing IP addresses corresponding to particular targets for which it is currently conducting surveillance, together with call status and/or other useful information.

It should be understood that various embodiments are described herein in connection with logical groupings of functions. One or more embodiments may omit one or more of these logical groupings. Likewise, in one or more embodiments, functions may be grouped differently, combined, or augmented. Also, in one or more embodiments, the functions (for example, associating public identifier 1213, mapping public identifier 1215, authenticating 1221, and others) may be performed predominantly or entirely on a remote server (not illustrated); and therefore such functions can be reduced or omitted from the processor 1207 and distributed to the remote server. Similarly, the present description may describe or suggest a database or collection of data and information. One or more embodiments can provide that the database or collection of data and information can be distributed, combined, or augmented, or provided locally (as illustrated) and/or remotely (not illustrated).

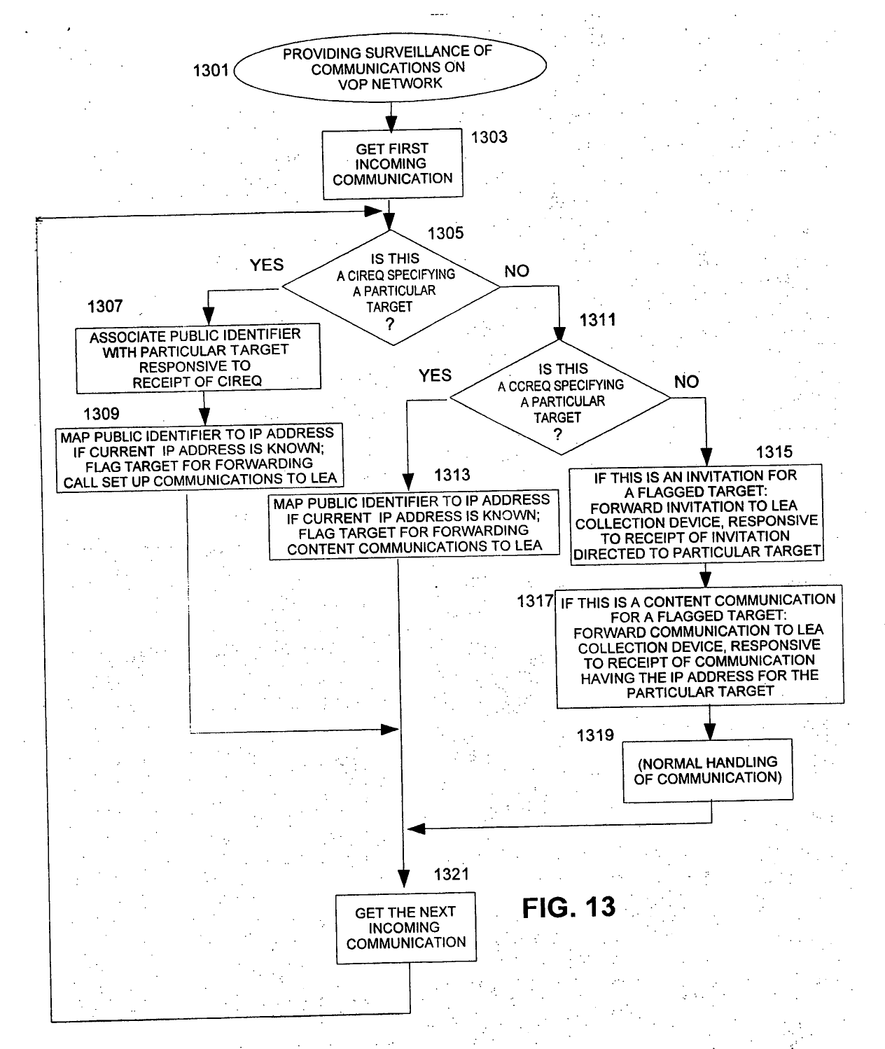

Referring now to FIG. 13, a flow chart illustrating an exemplary procedure for providing surveillance of communications on a voice over packet (VOP) network in accordance with various exemplary and alternative exemplary embodiments will be discussed and described. The procedure can advantageously be implemented on, for example, a processor of a controller, described in connection with FIG. 12 or other apparatus appropriately arranged. In overview, the procedure 1301 for providing surveillance of communications gets 1303 a first incoming communication, handles a CIReq 1305 by associating 1307 a public identifier with the target and mapping 1309 the public identifier to the current IP address; handles a CCReq 1311 by mapping 1313 the public identifier to the current IP address; handles other communications by forwarding 1315 CI communications and/or CC communication 1317 for targets before normal handling 1319 of the communications; and continues looping 1321 for more incoming communications. The illustrated parts of this exemplary procedure are described in more detail below.

The procedure 1301 can include getting 1303 a first incoming communication, in accordance with the usual techniques. In the illustrated procedure, the special handling for implementing surveillance is then performed, and (if appropriate) the normal handling for communications is performed last. However, other orders of processing may be used. The incoming communication is then processed.

First, the illustrated embodiment checks 1305 whether the incoming communication is a CIReq, which is handled differently from normal incoming communications. If the incoming communication is a CIReq, the process associates 1307 a public identifier with the particular target specified in the CIReq. Methods for associating the public identifier have been discussed above. Then, the process maps 1309 the public identifier to the current IP address, if the current IP address is known. This also has been previously discussed in more detail, and an exemplary procedure for mapping is illustrated in FIG. 14. The illustrated embodiment then sets up a flag indicating the target so that call set up communications to/from the target can be readily identified and forwarded to the LEA. Having handled the CIReq, the process can get 1321 the next incoming communication and loop back to the beginning of the process 1301.

If the particular target in the CI Req is not currently using the VOP network, it is not possible to map the public identifier to an IP address. Therefore, the process can provide for a sub-process to store unmapped public identifiers and to later attempt to map un-mapped public identifiers to IP address. This can be done, for example, at each new call, periodically, or at another appropriate time.

Next, the illustrated embodiment checks 1305 whether the incoming communication is a CCReq 1311, which is also handled differently from normal incoming communications. By definition, the CIReq has previously caused the particular target to be associated with the public identifier. The process can map 1313 the public identifier to the current IP address. The illustrated embodiment also provides for a flag indicating the target so that call content communications to/from the target can be forwarded to the LEA. Having handled the CCReq, the process can get 1321 the next incoming communication and loop back to the beginning of the process 1301.

If the incoming communication is neither a CCReq nor a CIReq, it may be a CI communication or CC communication that should be forwarded to the LEA. Thus, the process 1301 provides for checking whether the incoming communication is a CI communication and processing it appropriately. For example, as illustrated, if 1315 the incoming communication is an invitation corresponding to a flagged target, a copy of the invitation is forwarded to the LEA collection device. Accordingly, one or more embodiments provide for forwarding information corresponding to call set up information for the particular target to the LEA collection device, responsive to the CI request. The forwarded information can include, in some embodiments, signaling security information and/or media security information Also, the process 1301 provides for checking 1317 whether the incoming communication is a call content communication corresponding to a flagged target (such as by checking the IP address) and if so, forwarding a copy of the communication to the LEA collection device. Accordingly, one or more embodiments provide for, responsive to a CCReq specifying the particular target, forwarding the communications to the LEA collection device.

Then, the incoming communication that is neither a CCReq nor a CIReq is handled 1319 according to normal procedures. For example, the communication can be passed on to the next node in the VOP network, or the like. Having handled the normal incoming communication, the process can get 1321 the next incoming communication and loop back to the beginning of the process 1301.

The process can be implemented on any or all of the network infrastructure devices. Accordingly, one or more embodiments provides a computer-implemented method, implemented on a call server, for providing surveillance of communications on a voice over packet (VOP) network, comprising: at the call server, responsive to receipt of a call setup information request (CIReq) indicating a particular target, associating a public identifier with the particular target, and mapping the public identifier to an internet protocol (IP) address responsive to a communication; at the call server, responsive to receipt of at least one invitation directed to the particular target, forwarding the at least one invitation to law enforcement agency (LEA) collection device; and at the call server, responsive to receipt of communications to/from the IP address, forwarding the communications to the LEA collection device.

Additional subprocesses can be provided, for example, for clearing flags for a target when a call is terminated.

It is also anticipated that alternate implementations can be realized based on the following description. For example, when a packet to or from a particular target is processed, a duplicate of the packet can be used as the RCI or RCC packet, and can be scheduled for transmission to the LEA collection device, at an appropriate layer of the protocol. Also, although this example illustrates a particular target, the same principles an be utilized to perform surveillance on multiple targets.

Referring now to FIG. 14, a flow chart illustrating an exemplary procedure 1401 for mapping a public identifier to an Internet protocol address will be discussed and described. This is merely an example, as alternate implementations can be realized based on the descriptions provided herein. The procedure can advantageously be implemented on, for example, a processor of a controller, described in connection with FIG. 12 or other apparatus appropriately arranged.

The procedure 1401 for mapping a public identifier to an internet protocol address includes, in overview, obtaining 1403 the public identifier, checking 1405 whether the public identifier is on an IP address, and if so, returning the IP address 1407. Otherwise, the process 1401 can return 1409 an indicator that the public identifier does not map to an IP address. A more detailed description follows.

First, the illustrated procedure 1401 obtains 1403 the public identifier. This can be passed in as a parameter. This example assumes that the public identifier has previously been obtained.

Then, the illustrated procedure checks 1405 whether the public identifier is currently associated with an IP address. For example, the procedure can access information listing public identifiers which are currently logged in, and IP addresses associated with the logged-in public identifiers. Such information could be obtained, for example, from a table or database. The illustrated example assumes that there is a process for saving information about public identifiers and IP addresses on which they are currently located.

If the public identifier is logged on to an IP address, then 1407 the process returns the IP address associated with the specified public identifier. In the illustrated embodiment, the IP address can be returned 1411 as a parameter.

On the other hand, if the public identifier is not logged on to an IP address, then the process 1401 can return 1409 an indicator that the public identifier currently does not map to an IP address. In the illustrated embodiment, the indicator that the public identifier does not map can be returned 1411 as a parameter.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A network infrastructure device in a voice over packet (VOP) network, comprising:
a transceiver operable to transmit and receive communications over at least a portion of a VOP network; and
a processor cooperatively operable with the transceiver, and configured to facilitate, responsive to receipt of a call setup information request (CIReq) specifying a particular target, associating a public identifier with the particular target, and mapping the public identifier to an internet protocol (IP) address responsive to a communication; identifying communications at least one of to and from the particular target with the IP address; and responsive to receiving communications at least one of to and from the IP address, transmitting the communications to a law enforcement agency (LEA) collection device.

2. The device of claim 1, wherein the mapping is responsive to a call content request (CCReq).

3. The device of claim 1, wherein the VOP network is a peer-to-peer network and the network infrastructure device is an edge router,
further comprising, responsive to a call content request (CCReq) specifying the particular target, and responsive to receiving communications at least one of to and from the particular target, forwarding the communications to the LEA collection device.

4. The device of claim 1, wherein the VOP network is a peer-to-peer network, further comprising identifying at least one of a signaling security information and a media security information from a sequence of communications, and forwarding the at least one signaling security information and media security information exchanged with the particular target to the LEA collection device.

5. The device of claim 1, wherein the communications at least one of to and from the particular target are forwarded only after the particular target is authenticated.

6. The device of claim 5, wherein the particular target is authenticated by at least one of a device identification and a subscriber identification.

7. The device of claim 1, further comprising forwarding at least one of a signaling security information and a media security information corresponding to the particular target to the LEA collection device.

8. The device of claim 1, further comprising providing media information describing the media of the communications at least one of to and from the particular target to the LEA collection device.

9. The device of claim 1, wherein the network infrastructure device is an edge router.

10. The device of claim 1, wherein the network infrastructure device is a centralized media gateway.

11. The device of claim 1, wherein the network infrastructure device is a session border controller.

12. The device of claim 1, wherein the network infrastructure device is a media gateway.

13. The device of claim 1, wherein the network infrastructure device is a trunk gateway.

14. The device of claim 1, wherein the network infrastructure device is a media box.

15. The device of claim 1, wherein when the CIReq specifies a secondary target in connection with the particular target, further comprising,
responsive to receipt of the CIReq specifying a secondary target in connection with the particular target, associating a secondary public identifier with the secondary target, mapping the secondary target to a secondary internet protocol (IP) address responsive to the communications, and identifying communications between the particular target and the secondary target,
wherein the communications that are transmitted to the LEA collection device are between the particular target and the secondary target.

16. A computer-implemented method, implemented on a call server, for providing surveillance of communications on a voice over packet (VOP) network, comprising:
at the call server, responsive to receipt of a call setup information request (CIReq) indicating a particular target, associating a public identifier with the particular target, and mapping the public identifier to an internet protocol (IP) address responsive to a communication;
at the call server, responsive to receipt of at least one invitation directed to the particular target, forwarding the at least one invitation to law enforcement agency (LEA) collection device; and
at the call server, responsive to receipt of communications at least one of to and from the IP address, forwarding the communications to the LEA collection device.

17. The method of claim 16, further comprising forwarding at least one of a signaling security information and a media security information corresponding to the particular target to the LEA collection device, responsive to the CI request.

18. A computer-readable medium comprising instructions for execution by a computer, the instructions including a computer-implemented method for providing surveillance of communications on a voice over packet (VOP) network, the instructions for implementing:
(A) receiving a call setup information request (CIReq) specifying a particular target, and responsive thereto, associating a public identifier with the particular target and mapping the public identifier to an internet protocol (IP) address;
(B) identifying communications at least one of to and from the particular target with the IP address; and
(C) responsive to receiving communications at least one of to and from the IP address, transmitting the communications to a law enforcement agency (LEA) collection device.

19. The computer-readable medium of claim 18, further comprising instructions for implementing: responsive to a CCReq specifying the particular target, forwarding the communications to the LEA collection device.

20. The computer-readable medium of claim 18, further comprising instructions for implementing: identifying at least one of a signaling security information and a media security information from a sequence of communications, and forwarding the at least one of signaling security information and media security information exchanged with the particular target to the LEA collection device.

21. The computer-readable medium of claim 18, further comprising instructions for implementing: providing media information describing the media of the communications at least one of to and from the particular target to the LEA collection device.

22. The computer-readable medium of claim 18, wherein the CIReq specifies a secondary target in connection with the particular target, further comprising instructions for implementing: responsive to receipt of the CIReq, associating a secondary public identifier with the secondary target, mapping the secondary target to a secondary internet protocol (IP) address responsive to the communications, and identifying communications between the particular target and the secondary target, wherein the communications that are transmitted to the LEA collection device are between the particular target and the secondary target.
